(19) United States
(12) Patent Application Publication
(10) Pub. No.: US 2024/0391086 A1
(43) Pub. Date: Nov. 28, 2024

(54) WORKBENCH SYSTEM

(71) Applicant: Automata Technologies Limited, London (GB)

(72) Inventors: Laura GRANDE, London (GB); Andrea ANTONELLO, London (GB); Michele GHILARDI, London (GB); Edward Arthur WORTHINGTON, London (GB); Tamas Andras FEHER, London (GB); Ross William Robert MONTGOMERY, London (GB); Michael Leslie GROUT, London (GB); Ryan Tomas WHEELER, London (GB); Davide PAGANINI, London (GB); Rowan James GIFFORD, London (GB); Hannah Marianne T. DALED, London (GB); Tommaso PARDI, London (GB); Mahdi Asef SHAH, London (GB); Matthew John GROVE, London (GB); Wain James DUDLEY-MULLINS, London (GB); Athanasios KORKOVELOS, London (GB)

(21) Appl. No.: 18/793,532

(22) Filed: Aug. 2, 2024

Related U.S. Application Data
(63) Continuation-in-part of application No. PCT/GB2023/050238, filed on Feb. 3, 2023.
(63) Continuation-in-part of application No. PCT/GB2023/050239, filed on Feb. 3, 2023.

(30) Foreign Application Priority Data
Feb. 4, 2022 (GB) 2201481.5
Mar. 31, 2022 (GB) 2204639.5

(51) Int. Cl. B25H 1/00; B25H 1/02; B25J 11/00

(52) U.S. Cl. CPC B25H 1/0078; B25H 1/02; B25J 11/008

(57) ABSTRACT

A method of installing a modular workbench system in a laboratory comprising installing a workbench having a work surface accessible to a user from a free side for user manipulation of objects on the work surface such that the side opposite to the free side is installed against an object. A robotic arm is mounted on the free side and has at last least three degrees of freedom to manipulate objects on the work surface. The workbench may comprise a rail extending along the free side to slidably support the robotic arm. The workbench may have a transport surface with a magnetic conveyor system to transport objects at a level below the work surface.

### CROSS-REFERENCE TO RELATED APPLICATIONS

This application is a continuation-in-part of International Application No. PCT/GB2023/050238, filed on Feb. 3, 2023, which claims priority of United Kingdom Application No. 2201481.5, filed on Feb. 4, 2022; this application is also a continuation-in-part of International Application No. PCT/GB2023/050239, filed on Feb. 3, 2023, which claims priority of United Kingdom Application No. 2204639.5, filed on Mar. 31, 2022 and United Kingdom Application No. 2201481.5, filed on Feb. 4, 2022. Each of the aforementioned applications are incorporated herein by reference in their entirety.

### BACKGROUND

### Field

The present disclosure relates to a workbench system. In particular, it is directed to a workbench system suitable for use in a laboratory facility or the like.

### Description of the Related Art

At present, laboratories have access to a wide variety of instruments from various manufacturers. However, these often have different eco systems and special limitations which create logistical challenges for automated workflow. The present invention is aimed at providing a workbench system which is designed to facilitate workflow automation within the laboratory environment.

The use of collaborative robots (robots which operate at low enough peak forces which allow them to work safely alongside people) is known in a laboratory context. For example, HighRes Biosolutions have of a system which uses a robotic arm on a rail mounted on a platform between two units mounted in a back to back configuration in order to move objects from a supply area on one side to a working area on the other side. Because the robotic arm is positioned on a platform between units, the overall structure is particularly bulky, thereby reducing or impeding manual access to the laboratory equipment, and making servicing of the system more difficult.

The present application claims priority to United Kingdom patent application No. 2201481.5, the entire contents of which is hereby incorporated by reference. This application discloses a further workbench system, focusing on the location of a robotic arm for a collaborative robot (robots which operate at low enough peak forces which allow them to work safely alongside people). The present disclosure can be applied to the workbench system as disclosed in this application.

In such an environment, the ability to move samples is particularly important. This may be for example to move samples around a single workbench—such as during a processing step. In further examples, the sample may need to be moved between multiple workbenches such as where different processing is carried out at different work stations on different workbenches.

Existing systems include trolleys running on tracks. Such systems require connection between any adjacent tracks to allow movement across different workbenches. This introduces a potential failure location and makes it more complicated to change the overall set-up of a system.

WO 2013/064662 A1 discloses a laboratory sample distribution system. An array of static electromagnets is selectively provided with an electric current in order to move a sample around a surface. A large number of electromagnets is required to cover the entire surface. It is therefore difficult to scale this system. The laboratory stations are spaced away from the transport plane, leading to a system with a large footprint that does not operate as a workbench.

WO 2010/085670 A1 discloses a transport system powered by short block linear synchronous motors. The rail system on which objects are moved restricts the available movement of the system.

WO 2015/042409 A1 discloses a transport system comprising a guideway having a plurality of regions in which one or more vehicles are propelled. Again, a large number of fixed propulsion coils are provided which are selectively activated to drive movement.

US 5 477 788 A discloses a magnetic levitating apparatus. Electromagnets are provided above an object to be levitated and attract the object to thereby levitate it. The levitated object moves along guide rails to transport this. The levitated object can therefore only be moved along these guide rails. Again, a large number of magnets are required, and this system is difficult to quickly scale.

### SUMMARY

According to a first aspect of the present invention, there is provided a workbench system comprising: a first workbench having a work surface accessible to a user from a free side of the workbench for user manipulation of objects on the work surface; and a robotic arm mounted on the free side of the workbench, the robotic arm having at least three degrees of freedom so as to be able to manipulate objects on the work surface; further comprising a rail extending horizontally along the free side of the workbench, the robotic arm being slidably mounted on the rail.

Rather than mounting the robotic arm in a location in which manual access to laboratory equipment is relatively limited between adjacent units, the present invention takes a fundamentally different approach by placing the robotic arm on the free side of the workbench. This avoids the need for the bulky three part structure in the prior art, namely a robot mounting platform and surrounding units either side of this platform to restrict access to the robotic arm. The present invention is therefore more versatile. In particular, it can occupy a similar space to that required by a conventional workbench thereby allowing it to replace a conventional workbench and be readily integrated into an existing workbench arrangement. Further, it lends itself much more readily to building up a modular system based on a number of adjacent workbenches as the basic unit forming an individual workbench is significantly smaller than the minimum unit in the prior art. As the rail extends along the free side it is directly adjacent to the space occupied by the user standing at the workbench.

Reference to the free side of the workbench is a reference to the side of a workbench at which the user stands to carry out their work on the workbench. The side opposite to the free side may be placed against a wall, another workbench or other equipment as the workbench is not required to be accessible from the opposite side by the user. The free side of the workbench is not blocked by any obstacle which makes accessibility of the work surface an impractical possibility for a user standing on the free side directly in front of the workbench.

The robotic arm may be mounted at any elevation on the free side, such as on, above or below the work surface.

In its simplest form, the workbench system may be a single work surface. Preferably, the workbench further comprises a second surface at a level different from that of, preferably below, preferably directly below, the work surface, the robotic arm being configured to be able to manipulate objects on the second surface. Thus, as well as moving objects and performing tasks across the work surface, the robotic arm can also load the work surface with objects from the second surface.

In this case, the second surface is preferably a transport surface via which objects are transported to and from the workbench. This second surface may, for example, just be a free surface and a shuttle or rover type system may be employed to move objects along the transport surface. Alternatively, the second surface may be provided with a conveyor system such as belt or a rail/carriage fixed track system. Thus, the second surface may be used to transport objects to and from the workbench, while the robotic arm can load objects from the second surface onto the work surface and vice versa, and also manipulate objects on the work surface. Using a second surface to transport objects between workbenches frees up the robot arm from such a task, which has a positive impact on the system's throughput.

In certain cases, the workbench system may comprise a plurality of second surfaces. These could be referred to as additional surfaces, or (for example) a third surface, a fourth surface, etc. The robotic arm then being configured to manipulate objections on/between each surface. Each additional surface may be at a different level, to the work surface and/or each other additional surface.

While the specific example of a second surface as a transport surface is noted above, this is not always the case. The other surfaces could include, for example, storage space, a place for consumables, a place for instruments, etc. or a further work surface.

The robotic arm may, for example, be an arm with degrees of freedom which are purely rotational allowing the robotic arm to be rotated to locations on the work surface and the second surface. However, preferably, the robotic arm is movable along a vertical axis between the work surface and the second surface. This provides more efficient movement between the two surfaces as well as minimising the number of axes of rotation and associated drives required of the robotic arm.

A SCARA robotic arm with two or more rotational degrees of freedom and movable along a vertical axis is particularly suitable for this application. The links do not have to rotate against the gravitational force thereby allowing the drive forces to be reduced, while the motion about the vertical axis provides a simple and quick way of moving between the work surface and the second surface.

In order to provide further versatility to the workbench, it may comprise an additional surface different from that of, preferably above the work surface, the robotic arm being configured to be able to manipulate objects on the additional surface. This additional surface allows for installing additional laboratory equipment in the same footprint or for the temporary placement of objects. In this scenario, the robotic arm should still be able to access the laboratory equipment installed on the additional surface, and/or to place and retrieve objects from the additional surface when necessary.

The workbench system lends itself particularly well to a modular construction in which a number of workbenches are arranged together. Therefore, the rail is preferably provided with coupling at one end for coupling, in use, to a rail of an adjacent workbench.

In this case, the workbench system preferably further comprises a second workbench attachable to the first workbench and having a work surface accessible to a user from a free side of the workbench. The second workbench preferably has a rail extending along the free side of the workbench and coupled to the rail of the first workbench such that the robotic arm can move between the rails of two workbenches.

The rail is preferably configured, in use, to allow the robotic arm to move in the region occupied, in use, by a user standing adjacent to the free side of the workbench to access the work surface. In this case, at the free side, the horizontal distance between the work surface and the rail is preferably less than 30 cm, more preferably less than 20 cm and most preferably less than 10 cm. This ensures that, in a horizontal sense, the rail is positioned relatively close to the workbench such that a user is able to stand relatively close to the workbench, while not being hampered by the rail.

The rail may be partially or entirely directly below the work surface. That is, within the footprint (in plan view) of the work surface. This can further allow the user to stand closer to the work surface.

Preferably, at the lowermost part of the free side of the workbench, there is a gap that is at least 5 cm high to allow a user's feet to be positioned under the workbench and to ease cleaning operations of the facility's floor. Thus, even though the rail extends towards the user, they can still stand comfortably at the workbench to access the work surface.

Preferably, a control box containing electronics for the robotic arm and other equipment, if present, is supported in the workbench and is withdrawable at the free side of the workbench. This provides an easy way of accessing the control electronics allowing ease of maintaining and upgrading of a workbench with new equipment.

According to a second aspect of the invention there is provided of equipping a laboratory, the method comprising installing a modular workbench system in the laboratory, including a first workbench having a work surface accessible to a user from a free side of the workbench for user manipulation of objects on the work surface; and a robotic arm mounted on the free side of the workbench, the robotic arm having at least three degrees of freedom so as to be able to manipulate objects on the work surface; the method further comprising installing the first workbench such that the side of the workbench opposite to the free side is installed against an object, and the free side of the workbench is unobstructed.

The object may, for example, be a wall, another workbench or other equipment. The equipment can therefore be optimised to fill the space available as the side of the workbench opposite to the free side is configured to be positioned against a wall or the like while the free side allows for user access.

The method preferably comprises installing further workbench systems in the laboratory. In this case, at least one of the further workbench systems is a second workbench which is attached to the first workbench and having a work surface accessible to a user from a free side of the workbench.

The robotic arm may be fixed on the workbench. However, preferably, the workbench system further comprises a rail extending along the free side of the workbench, the robotic arm being slidably mounted on the rail.

The first and second workbenches preferably each have a rail extending along the free side of the workbench, and the method preferably further comprises coupling to the rail of the first and second workbenches such that the robotic arm can move between the rails of two workbenches.

The first and second workbenches may have any of the preferred features of the workbench defined in relation to the first aspect of the invention.

According to a third aspect of the invention there is provided a workbench system comprising: a first workbench having a work surface accessible to a user for user manipulation of objects on the work surface; a transport surface at a level below the work surface: a robotic arm mounted to the workbench, and having at least three degrees of movement so as to be able to manipulate objects on the work surface and on the transport surface; wherein the transport surface is provided with a magnetic conveyor system to transport objects to and from the workbench.

The magnetic conveyor system may comprise permanent magnets or electromagnets.

A workbench system is provided comprising: a first workbench having a work surface and a transport layer at a different level to the work surface, wherein the transport layer comprises: a transport surface for supporting a shuttle carrier for carrying one or more samples, the transport surface defining a plane with an x direction and a perpendicular y direction; and a magnetic conveyor system arranged below the transport surface, comprising a coupling element for magnetic coupling through the transport surface in use with a shuttle carrier on the transport surface, the magnetic conveyor system configured to move the coupling element in the x direction or the y direction. This system allows for effective movement of a sample around a workbench for processing. The system can be easily scaled by adjusting the size of the magnetic conveyor system without the need for more magnets. Further, the provision of the work surface and transport layer at different levels provides a simple modular system with a minimised footprint.

The first workbench may further comprise a mounting for a robotic arm. This allows for an arm to be attached for further automation of the workbench system.

The workbench system may further comprise a robotic arm for moving a sample between the transport layer and the work surface. This allows for further automation of the workbench system. This robotic arm may be on a mounting on the first workbench, or any other suitable arrangement.

The magnetic conveyor system may be configured to move the coupling element in both the x direction and the y direction. This can increase the available movement of the sample around the workbench. In the broadest sense a sample moving in a single direction provides an operable system but movement in multiple directions further increases the flexibility of the system—particularly in handling multiple shuttle carriers on a transport surface as they can move around each other.

The coupling element may comprise a coupling magnet for magnetic coupling through the transport surface in use with a shuttle carrier on the transport surface. The coupling magnet may be a permanent magnet or an electromagnet. In alternatives, the coupling element may have one or more magnetic regions.

The coupling element may comprise a plurality of coupling magnets for magnetic coupling through the transport surface in use with a shuttle carrier on the transport surface. For example this may be with one or more shuttle magnets. Multiple coupling magnets may allow for a stronger magnetic coupling as well as providing additional flexibility which may be used, for example, in handover of a shuttle carrier between adjacent workbenches.

The or each coupling magnet may be a permanent magnet. Permanent magnets may be easier to incorporate into a system as well as using less power.

The coupling element may be selectively engageable and disengageable in use with a shuttle carrier on the transport surface. For example, this may be with one or more shuttle magnets. Engaging means being in magnetic coupling, and disengaged means not being in magnetic couple. Disengaging may also be referred to as decoupling. This may allow the shuttle carrier to be effectively picked up and dropped off at different positions on the transport surface. This may allow, for example, multiple shuttle carriers to be moved about a single transport surface. This could be achieved by selectively providing an electric current to an electromagnet or by vertical movement of a magnet as discussed further below.

The magnetic conveyor system may further comprise an actuation system configured to move the coupling element in a z direction towards and away from the transport surface, the z direction being perpendicular to the x direction and the y direction, for engaging and disengaging the coupling element and a shuttle carrier on the transport surface. This may be an effective way to engage and disengage a permanent magnet or an electromagnet without having to remove the electric current.

The magnetic conveyor system may further comprise an actuation system configured to rotate the coupling element about a z direction, the z direction perpendicular to the x direction and the y direction. This actuation system may be the same as the actuation system discussed above in relation to the z movement. For example, the actuation system may comprise one or more actuators which result in this rotational movement. Alternatively, this may be entirely separate to the actuation system of the z movement. Rotating the coupling element leads to rotation of the shuttle carrier which may further increase the flexibility of the system and allow for passing of shuttle carriers between workbenches around a bend.

The magnetic conveyor system may comprise a first rail and a second parallel rail, arranged at opposite edges of the transport surface or transport layer, and a third rail extending between the first rail and the second rail, wherein: the third rail is configured to move along the first rail and the second rail to move the coupling element in the x direction; and the coupling element is configured to move along the third rail to move in the y direction. This is also known as gantry XY and may be an effective system to move the coupling element across an entire underside of the transport layer.

The coupling element may further comprise an identification reader arranged to read identification information through the transport surface of a shuttle carrier carried on the transport surface. This allows information such as the identity of a shuttle carrier to be checked, further allowing for a more autonomous system.

The transport surface may comprise a handover region, wherein the handover region is reachable for moving a sample between the transport surface and the work surface. The handover region may provide an area of the transport surface which can be accessed by the robotic arm, this provides a defined region for stationary shuttle carriers to be placed. This keeps stationary shuttle carriers away from moving shuttle carriers.

The handover region may be reachable by the robotic arm in examples where this is present for moving a sample between the transport surface and the work surface.

The workbench system may further comprise an anchoring system for retaining a shuttle carrier in the handover region of the transport surface. The anchoring system may hold a shuttle carrier in place to ensure that it does not drift away from its intended position.

The handover region may be adjacent to an edge of the transport surface. Such a handover region may be more easily accessible by a user and/or a robotic arm.

The transport layer may be at a level below the work surface. This allows the transport layer to be put out of the way. For example, in a collaborative workspace the work surface may be at a level for easy user interaction with the transport layer below at a level that is not convenient for users to access.

The workbench system may further comprise an auxiliary conveyor system for moving a shuttle carrier on the transport surface. This auxiliary conveyor system may be generally the same as the magnetic conveyor system. Alternatively, it may be different such as a conveyor or conveyor belt. This auxiliary conveyor system may be responsible for transferring shuttle carriers between workbenches.

The workbench system may further comprise: a second workbench adjacent to the first workbench, the second workbench having a work surface and a transport layer at a different level to the work surface, wherein the transport layer of the second workbench comprises: a transport surface for supporting a shuttle carrier for carrying one or more samples, the transport surface defining a plane with an x direction and a perpendicular y direction; a magnetic conveyor system arranged below the transport surface, comprising a coupling element for magnetic coupling through the transport surface with a shuttle carrier on the transport surface via magnetic force through the transport surface, the magnetic conveyor system configured to move the coupling element in the x direction and/or the y direction. Adjacent workbenches such as these allow for sharing of the transport layer so as to allow movement of shuttle carriers and hence samples between workbenches which may include one or more work stations for processing of the sample.

The workbench system may further comprise a shuttle carrier for carrying one or more samples, the shuttle carrier comprising a plurality of shuttle magnetic regions. Each magnetic region may be a magnet itself (permanent or electromagnet). Alternatively, each magnetic region may only be a magnetic material. Having a plurality of shuttle magnetic regions may increase the magnetic coupling strength, as well as possibly facilitating passing of the shuttle carrier between transport layers of adjacent workbenches.

The plurality of shuttle magnets or magnetic regions may comprise a first magnet or magnetic region at a first end of the shuttle carrier and a second magnet or magnetic region at a second end of the shuttle carrier, the second end opposite to the first end. This may allow magnets or magnetic regions of the shuttle carrier to overhang the transport layer of a given workbench so as to allow passing to a second workbench. For example, the shuttle carrier may be substantially rectangular with each shuttle magnet or magnetic region arranged at a corner of the shuttle carrier.

Each shuttle magnetic region may comprise a shuttle magnet. That is, each shuttle magnetic region may be a magnet. Or a single magnet may be shared between regions. Using shuttle magnets can result in a stronger magnetic coupling, particularly if the coupling element also includes coupling magnets.

The robotic arm may comprise an alignment protrusion and the shuttle carrier may further comprise a complementary alignment surface, the alignment protrusion arranged to engage the complementary alignment surface to move the shuttle carrier in the x direction and/or the y direction. This allows the system to take advantage of the selective compliance of the coupling element and shuttle carrier to ensure correct alignment of the robotic arm and shuttle carrier.

The alignment surface may be a chamfered surface. This is a simple way to achieve the alignment.

The shuttle carrier may further comprise a sample-receiving surface supported by a biasing member, the biasing member biasing the sample-receiving surface in in a z direction away from the transport surface, the z direction perpendicular to the x direction and the y direction. This further allows for alignment in the z direction when picking up a sample from the shuttle carrier.

A method of transporting a sample is provided comprising the steps of: providing a workbench system as discussed herein; providing a shuttle carrier carrying a sample on the transport surface; magnetically coupling the coupling element and the shuttle carrier; moving the coupling element with the magnetic conveyor system to thereby move the shuttle carrier; and moving the sample to the work surface. This method allows a sample to be effectively moved about a workbench.

The workbench system may further comprise a robotic arm for moving a sample between the transport layer and the work surface, and the method may further comprise the step of picking up the sample with the robotic arm. This allows for further automation of the workbench system.

A method of passing a shuttle carrier for carrying one or more samples between a first workbench and a second workbench adjacent to the first workbench is provided, the shuttle carrier comprising a plurality of shuttle magnetic regions, wherein each workbench comprises a transport surface for supporting a shuttle carrier, the transport surface defining a plane with an x direction and a perpendicular y direction; and a magnetic conveyor system arranged below the transport surface, comprising a coupling element including a coupling magnetic region, wherein one or both of the shuttle magnetic regions or the coupling magnetic region is a magnet, the coupling magnetic region for magnetic coupling through the transport surface with a shuttle magnetic region on a shuttle carrier on the transport surface, the magnetic conveyor system configured to move the coupling element in the x direction and/or the y direction, the method comprising the steps of: i. engaging the shuttle carrier with the coupling element of the first workbench; ii. moving the coupling element of the first workbench to move the shuttle carrier to an edge of the transport surface of the first workbench; iii. engaging the shuttle carrier with the coupling element of the second workbench; and iv. moving the coupling element of the second workbench to move the shuttle carrier to a position where the shuttle carrier is fully supported on the transport layer of the second workbench. This method provides an effective way to pass a shuttle carrier between adjacent workbenches, so as to provide a flow of samples through the workbench system. Each magnetic region may be a magnet.

Between step ii and iii, there may be the additional step of disengaging the shuttle carrier from the coupling element of the first workbench. In other examples the engagement of the first magnetic region of the shuttle carrier with the coupling element of the second workbench may be sufficiently strong to overcome the engagement of the shuttle carrier with the coupling element of the first workbench.

In step ii, the coupling element can move the shuttle carrier to a position where the shuttle carrier overhangs the edge of the transport surface of the first workbench with at least a first shuttle magnetic region of the plurality of shuttle magnetic regions of the shuttle carrier above the transport surface of the second workbench. This means that the shuttle carrier is at least partially above the second transport surface and hence can easily be magnetically coupled to the second coupling element. In alternatives, the coupling element may move the shuttle carrier near to the edge and the coupling element of the second workbench can magnetically couple to the shuttle carrier from here.

The plurality of shuttle magnetic regions may comprise a first shuttle magnetic region and a second shuttle magnetic region, and the coupling element of the first workbench may comprise a first coupling magnetic region and a second coupling magnetic region. Step i may then correspond to engaging the first shuttle magnetic region of the shuttle carrier with the first coupling magnetic region of the coupling element of the first workbench and the second shuttle magnetic region of the shuttle carrier with the second coupling magnetic region of the coupling element of the first workbench. The method may further comprise, between step i and step ii, the steps of: i-1. moving the coupling element of the first workbench to move the shuttle carrier to a position where the shuttle carrier is adjacent the edge of the transport surface of the first workbench; i-2. disengaging the first shuttle magnetic region of the shuttle carrier from the first coupling magnetic region of the coupling element of the first workbench and the second shuttle magnetic region of the shuttle carrier from the second coupling magnetic region of the coupling element of the first workbench; i-3. moving the coupling element away from the edge of the transport surface of the first workbench; and i-4. engaging the second shuttle magnetic region of the shuttle carrier with the first coupling magnetic region of the coupling element of the first workbench. This may mean that full engagement of the shuttle carrier is achieved for normal movement, followed by a back-and-forth movement of the coupling element to pass the shuttle carrier to the adjacent workbench.

The plurality of shuttle magnetic regions may comprise a first shuttle magnetic region and a second shuttle magnetic region, and the coupling element of the second workbench may comprise a first coupling magnetic region and a second coupling magnetic region. Step iii may then correspond to engaging the first shuttle magnetic region of the shuttle carrier with the second coupling magnetic region of the coupling element of the second workbench. The method may further comprise, between step iii and step iv, the steps of: iii-1. moving the coupling element of the second workbench to move the shuttle carrier to a position where the shuttle carrier is adjacent an edge of the transport surface of the second workbench; iii-2. disengaging the first shuttle magnetic region of the shuttle carrier from the second coupling magnetic region of the coupling element of the second workbench; iii-3. moving the coupling element towards the edge of the transport surface of the second workbench; and iii-4. engaging the first shuttle magnetic region of the shuttle carrier with the first coupling magnetic region of the coupling element of the second workbench and the second shuttle magnetic region of the shuttle carrier with the second coupling magnetic region of the coupling element of the second workbench.

The first shuttle magnetic region may be provided at a first end of the shuttle carrier and the second shuttle magnetic region may be provided at a second end of the shuttle carrier, the second end opposite to the first end. This may make it simple to have a magnet overhanging the work surface of the first workbench and thereby simplify the handover process. For example, the shuttle carrier may be substantially rectangular with each magnet arranged at a corner of the shuttle carrier. There may be a plurality of first magnets and/or a plurality of second magnets.

Each coupling element may comprise a plurality of coupling magnetic regions; and at steps i and iv each of the shuttle magnetic regions may be engaged with a corresponding coupling magnetic region. This may allow for a strong magnetic coupling in normal movement of the shuttle carrier across the respective work surface.

Each magnetic region may comprise a magnet. Magnets can result in a strong attachment between the shuttle carrier and coupling element.

### BRIEF DESCRIPTION OF THE DRAWINGS

Examples of workbench systems in accordance with the present invention will now be described with reference to the accompanying drawings, in which:

FIG. 1 is a perspective view of the first workbench system with a first workbench;

FIG. 2 is a view similar to FIG. 1, showing two workbenches in a workbench system;

FIG. 3A is a schematic cross-section showing a first workbench;

FIG. 3B is a schematic cross-section showing a second workbench;

FIGS. 4A-D are plan views showing various workbench layouts;

FIG. 5 is a perspective view of the robotic arm and rail of a first system;

FIG. 6 is an exploded perspective view of the first robotic arm;

FIG. 7 is a view similar to FIG. 1 showing a further example of a workbench system;

FIG. 8 shows a perspective view of a workbench system with a single workbench;

FIG. 9 shows a perspective view of a workbench system including a plurality of workbenches;

FIG. 10 shows a top schematic view of a transport layer of a workbench system;

FIG. 11 shows a side schematic view of a workbench system;

FIGS. 12A to 12H sequentially show a side schematic view of a transport layer of a first workbench in a handover process to a transport layer of a second workbench;

FIG. 13 shows a perspective view of a robotic arm picking up a sample tray from a sample carrier;

FIG. 14 shows an expanded perspective view of a robot arm engaging a sample carrier; and

FIGS. 15A to 15E sequentially show a side schematic view of a robotic arm picking up a sample tray from a shuttle carrier.

### DETAILED DESCRIPTION

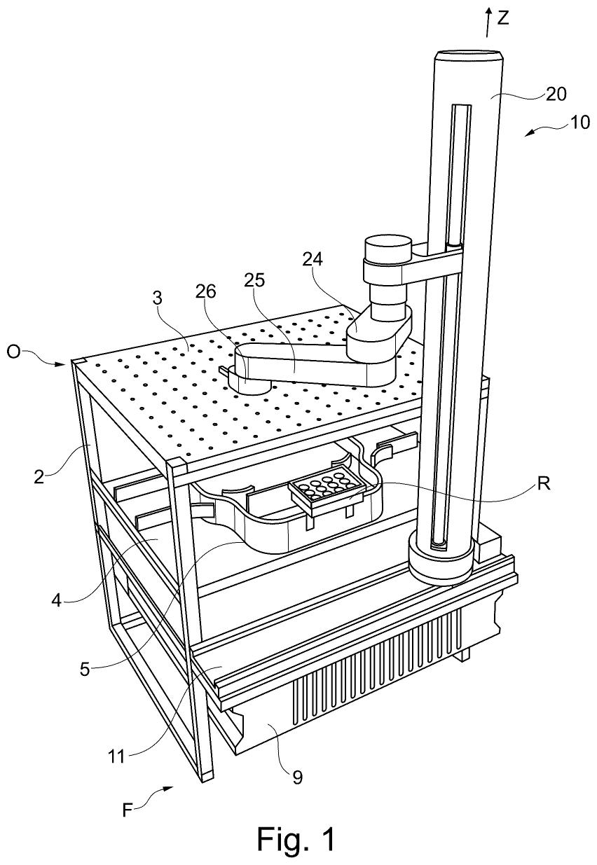

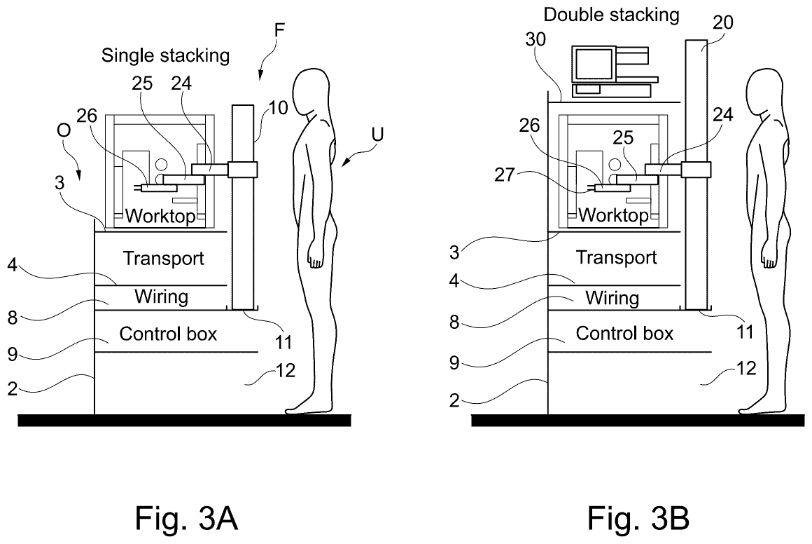

The workbench system is made of a plurality of workbenches with a modular construction. A first workbench 1 is shown in FIGS. 1 and 3A.

This has a framework 2 made, in the illustrated example, of a number of hollow square tubes which form the main structure of the workbench and provide support for a number of the features described below. However, any adequately sized material and frame design to sustain the mechanical stresses of the system can be used.

At the top of the workbench is a work surface 3 which is at a height to allow easy access for a user U standing on the free side F of the workbench. The opposite side O is installed against a wall, other equipment or another workbench as the workbench is not designed to be accessed by a user from that side.

Beneath the work surface 3 is a second surface 4. As shown in the Figures, this could be a transport surface 4, in this case provided with a transport rail 5 along which equipment can be moved to and from the workbench. The transport surface 4 may also be referred to as a transport layer 4. Below the transport surface 4 is a wiring layer 8 which connects to a control box 9 immediately beneath it or in the vicinity of it. This provides a simple way of making electrical connections to and from the control box 9 for the work surface 3, transport surface 4 and robotic arm 10. The control box 9 may be in the form of a pull-out drawer accessible from the first side F for ease of maintenance and to allow easy upgrading of the workbench in the event that new equipment is installed.

The transport surface is a generally horizontal surface allowing objects to be transported across the surface and to be moved to and from the workbench. As an alternative to the rail, the conveyor could be a moving belt or a shuttle system. A further alternative is a magnetic system. In this case magnets may selectively engage with objects to be transported. The magnets may be selectively movable permanent magnets or may be selectively operable or movable electromagnets.

In certain examples, there may be a plurality of second surfaces 4. These could be referred to as additional surfaces and/or numbered with consecutive ordinal numbering (i.e. second surface, third surface, fourth surface, etc.). Each additional surface may be at a different level, such as below, the work surface 3. Each additional surface may be at a different level to each other additional surface. One of these additional surfaces may be the transport surface 4 discussed above. Further uses of additional surfaces could include, for example, storage space, a place for consumables, a place for instruments, etc. or a further work surface 3.

The robotic arm 10 is mounted on a horizontal rail 11 which is on the free side F of the workbench 1. The robotic arm 10 is mounted on the free side F of the workbench 1—i.e. it is physically located at or on this free side F. In this example, the rail 11 is at a vertical location just below the transport surface 4. The rail 11 extends horizontally along the free side F of the workbench 1. That is, the rail 11 extends along the free side F in the horizontal direction. The rail 11 may be adjacent to the free side F (in either direction). For example, the rail 11 may be substantially parallel to the free side F.

As shown in FIG. 3A, in the horizontal sense, there is little or no horizontal gap between the work surface 3 and the rail 11 allowing a user U to stand comfortably on the free side F and to manipulate objects and manually operate laboratory equipment machines on the work surface 3. A gap 12 is provided at the lowermost portion of the free side F to allow a user U to stand even closer in a position where their feet are underneath the rail 11 providing comfortable access to the work surface 3. The rail 11 can be a single linear component shared across multiple benches or could be made up of different modules which mate together so as to ensure a smooth transition. The robotic arm can be driven or manually moved along the rail and can lockable at various locations along the rail if required.

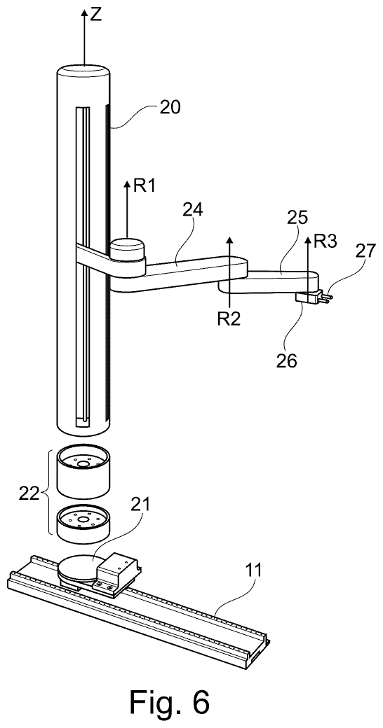

The robotic arm 10 has a vertical support turret 20 which is mounted on the rail 11 on a carriage 21 (see FIG. 6) so that it can slide along the rail 11. As shown in FIG. 6, the turret 20 may itself be rotatable on a rotatable platform 22. The turret 20 supports a series of linkages which are movable together along the turret 20 in a vertical direction along the vertical axis Z. The linkages comprises three rotatable links 24, 25, and 26 each of which is rotatable about a respective rotary axis R1, R2 and R3. The third arm 26 is provided with an actuator 27 for manipulation of objects on the work surface 3. The actuator may be a simple actuator such as a pincer with a single degree of freedom, or a more complex tool with multiple degrees of freedom.

While FIGS. 1 to 3B show the rail 11 as extending horizontally beyond the work surface 3, this is not necessarily the case. In fact, the rail 11 may be vertically below (partially or entirely) the work surface 3 and/or the transport surface 4. That is, the rail 11 is within the footprint of the work surface 3. In such a case, the robotic arm 10 may effectively be on a cantilever from the rail 11. For example, the carriage 21 may comprise a horizontally-extending plate which extends to a point horizontally-spaced from the work surface 3. The robotic arm 10 can then be mounted on this horizontally-extending plate. Such a rail 11 is still extending horizontally along the free side F of the workbench 1 as it is placed adjacent to this free side F in the same manner as the rail 11 shown in FIG. 1, but offset from the free side F in the opposite direction to the rail 11 of FIG. 1. In other words, the rail 11 is inside the framework 11.

In this example, the robotic arm 10 therefore has three axis of rotation R1, R2 and R3 and a linear axis Z as well as having the option of a further axis of rotation about rotational axis Z.

As shown in FIGS. 1 and 3A, an object such as a rack R containing an array of samples can be transported to the workbench 1 along the transport rail 5. The robotic arm 10 can then move vertically downwardly on axis Z whereupon the links 24, 25 and 26 can be moved into place allowing the actuator 27 to grip the rack R. The rotatable links 24, 25 and 26 are rotated back such that they clear the work surface 3 before being moved up along the vertical axis Z and rotated across the work surface 3 to the desired location to deposit the rack R. The process can be reversed to replace the rack R on the transport surface 4.

A variation of the workbench is shown in FIG. 3B. This is the same as the example in FIG. 3A except that it is provided with an additional surface 30 which is directly above the work surface 3 and the turret 20 is extended vertically such that the additional surface 30 can be accessed by the robotic arm 10.

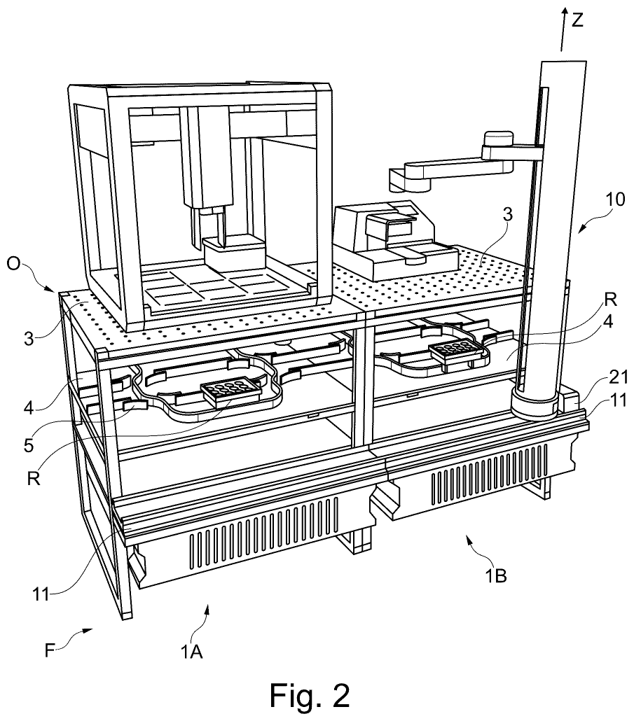

The modular arrangement will now be described first with reference to FIG. 2. This Figure essentially shows two workbenches, one 1A on the left hand side and the other 1B on the right hand side. The two modules are positioned adjacent to one another and the frames 2 in each case may be provided with a coupling in order to retain the two workbenches securely together. The workbenches are essentially as shown in FIG. 1 and they are illustrated with different items of equipment on their work surfaces 3.

When the workbenches 1A, 1B are in this position, the rails 11 are adjacent to one another. The rails have an open ended configuration at the interface between the two workbenches such that the carriage 21 of the robotic arm 10 can move between the two workbenches. This allows a single robotic arm 10 to service both the workbenches 1A and 1B.

Thus, for example, the rack R of samples may be delivered along with transport rail 5 of the left hand workbench 1A. These can be unloaded by the robotic arm 10 onto the work surface 3 of the first workbench 1A where one or more operations will be performed. The rack R can then be transferred by the robotic arm 10 to the work surface 3 of the second workbench 1B for further operations to be carried out before being transferred, by the robotic arm 10, to the transport surface 4 of the second workbench 1B.

Thus loading and unloading as well as additional manipulation of objects can occur at numerous workbenches using a single robotic arm 10. In general, this configuration allows for the sharing of different robotic arms 10 across workbenches 1. The number of robotic arms 10 can be different from the number of workbenches 1. One or more of the workbenches shown in FIG. 2 can have the additional surface 30 as shown in FIG. 3B for additional flexibility.

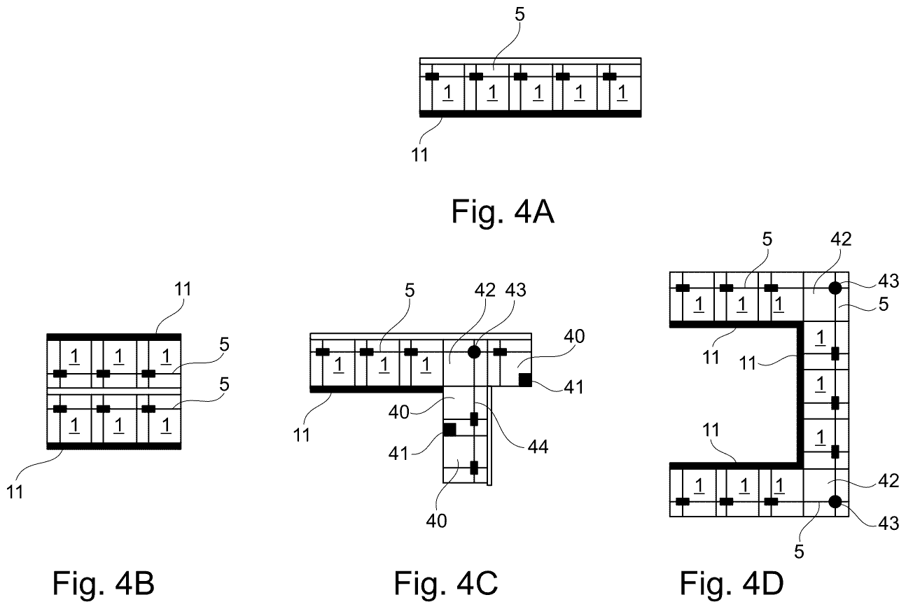

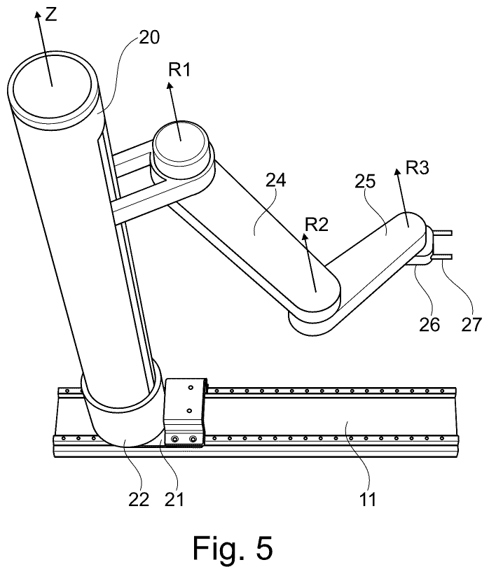

The invention is not limited to having two workbenches side by side. The workbenches can be connected in any desired configuration with a number of examples being shown in FIG. 4A to 4D.

In FIG. 4A five workbenches 1 are shown connected side by side with rail 11 installed as a number of modules in a linear configuration spanning the free side of these workbenches potentially allowing a single robotic arm to service all of the workbenches 1. The rail 11 can be configured in accordance with the user's needs. Thus, the rail 11 may not extend the full extent of the five workbenches. Alternatively, there may be two or more rails 11 each serving one or more of workbenches 1. The transport rail 5 extends across each of the workbenches 1

FIG. 4B shows two banks of workbenches 1 arranged back to back with the rail 11 extending along each of the free sides of the workbenches. A transport rail 5 extends across each of the three workbenches 1 and can be configured for transfer of objects between the two banks.

FIG. 4C shows an example of a T-shaped arrangement in which three of the workbenches 1 share a common rail 11. There are then two workbenches 40, which have fixed turrets 41 for robotic arms in order to serve adjacent work surfaces. A corner workbench 42 which is not provided with a rail 11 is provided at the junction of the T-shaped arrangement. The transport rail 5 extends across each of the workbenches 1, the corner module 42 and adjacent workbench 40. The corner workbench 42 has a junction 43 providing an interface to a secondary transport rail 44 which allows access to the remaining workbench 40.

The example of FIG. 4D has nine workbenches 1 arranged in groups of 3 around adjacent sides of a U-shaped configuration. Each side has its own rail 11. The corner modules 42 complete this arrangement and the junctions 43 allow the transport rail 5 to provide transportation along the transport layer 4 around all of the modules.

These examples are provided in order to give some idea of the versatility of the present invention and its use of a modular system. Any of the workbenches 1 may comprise the additional surface 30 as necessary and any of the workbenches with a rail 11 can be replaced by a similar workbench 40 without the rail (optionally with a fixed robotic arm 41).

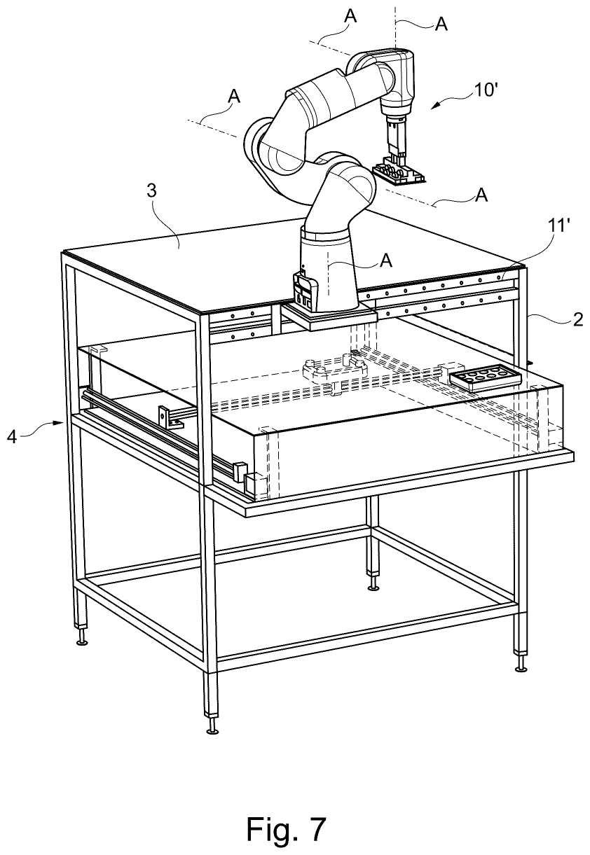

FIG. 7 shows a second example of a workbench. The details of this example are largely the same as the first example and only the differences will be described here. Essentially, the differences relate to the type of robotic arm 10′ and the rail 11′. As shown in FIG. 7 the rail 11′ still runs horizontally. However, in this case, rather than being in a horizontal plane, the rail 11′ is arranged in a vertical plane (the rail of the first example could similarly be in this vertical plane). Thus, the rail 11′ is mounted immediately below the work surface 3. The only linear movement of the robotic arm 10′ is along the rail 11′. Other than that, the robot is provided with multiple axes A of rotation. This robot is in accordance with our earlier WO 2020/084316 and reference is made to that document for further details of the robotic arm. Rather than moving vertically from the work surface 3 to the transport surface 4, the robotic arm 10′ swings about its multiple axis rotation between the two levels.

In another example of a workbench, the rail 11 of the workbench 1 is vertically (or directly) below the work surface 3 and/or the transport surface 4. The rail 11 may be entirely below the work surface 3, but in further examples the rail 11 may be only partially below the work surface 3. The robotic arm 10 is supported on a carriage 21 which acts as a cantilever from the rail 11. The carriage 21 comprises a flat plate extending horizontally from the rail 11. In other words, the rail 11 is inside the framework 11.

The robotic arm 10 may be in accordance with any of the examples discussed herein. In a specific example this may be a robotic arm 10 having a vertical support turret 20. Again, this turret 20 may be itself rotatable. The turret 20 supports a series of linkages which are movable together along the turret 20 in a vertical direction along the vertical axis Z. The linkages comprises three rotatable links 24, 25, and 26 each of which is rotatable about a respective rotary axis R1, R2 and R3. The third arm 26 is provided with an actuator 27 for manipulation of objects on the work surface 3. The actuator 27 may be a simple actuator such as a pincer with a single degree of freedom, or a more complex tool with multiple degrees of freedom.

The workbench 1 can include a plurality of second surfaces 4. However, the workbench 1 may be in accordance with any of the examples discussed herein. Each of the second surfaces 4 may be used as one of a transport layer; storage space, a place for consumables, a place for instruments, etc. or a further work surface 3. There may be a second surface 4 above the work surface 3 and/or a second surface 4 below the work surface 3.

In this example a first workbench 1 may again be placed adjacent to a second workbench 1, with the rails 11 adjacent to each other. Again, the rails 11 may have an open ended configuration at the interface between the two workbenches 1 such that the carriage 21 of the robotic arm 10 can move between the two workbenches 1.

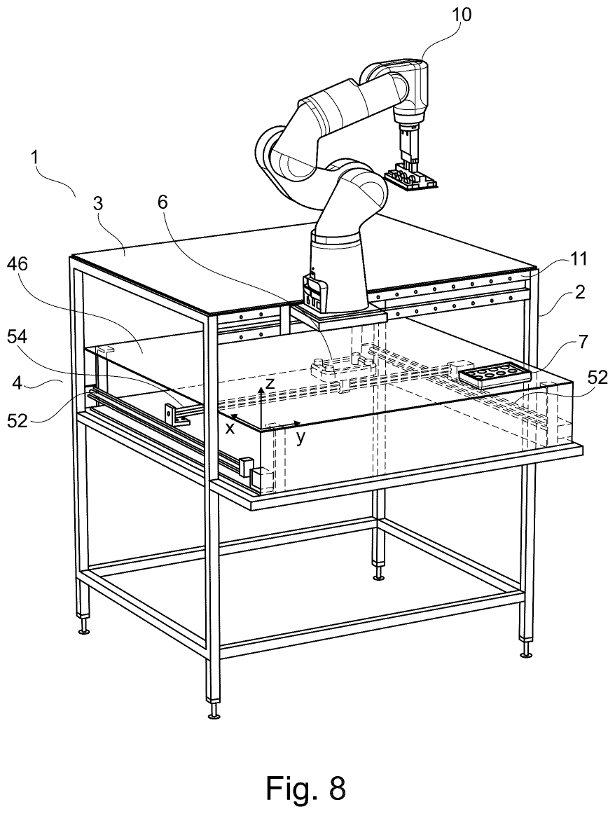

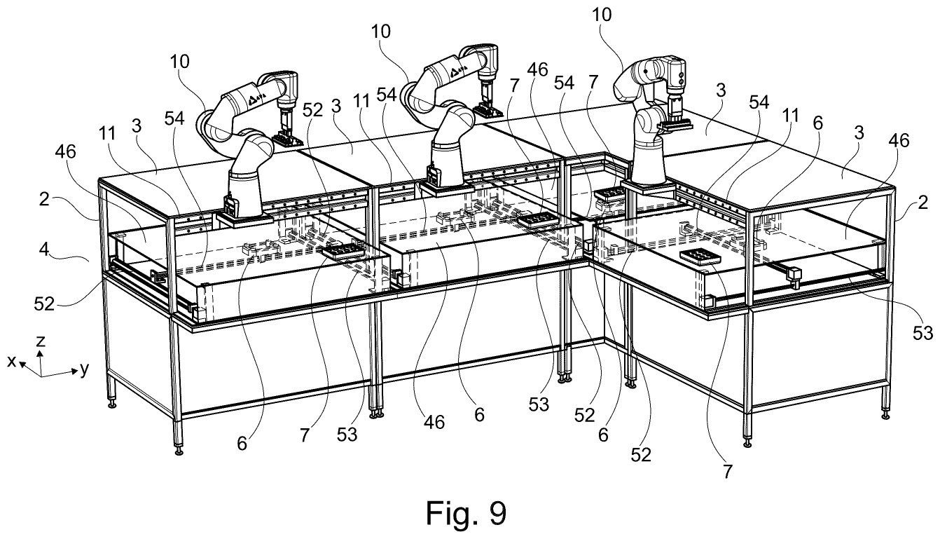

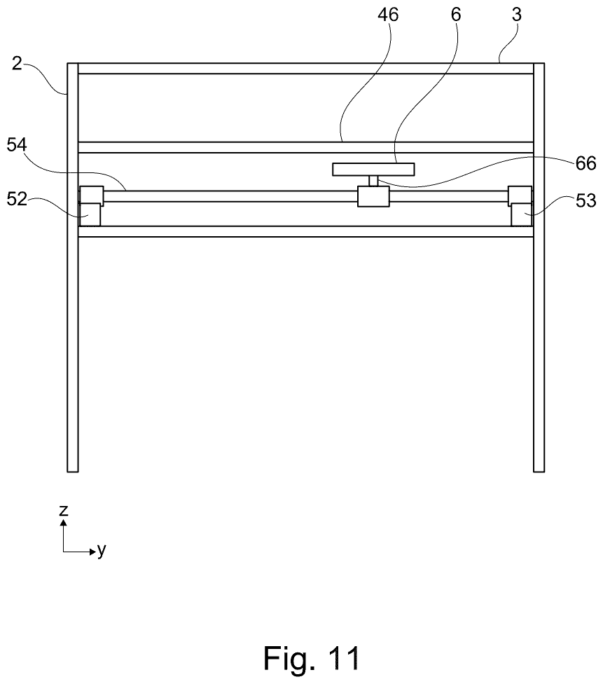

A first workbench 1 which may form a part of a workbench system is shown in FIG. 8. A side schematic view of this workbench is also shown in FIG. 11. The workbench system can be formed of a plurality of workbenches 1 such as shown in FIG. 9.

The workbench 1 may have a framework 2 made, as in the current Figures, of a number of hollow square tubes which form the main structure of the workbench and provide support for a number of the features described below. However, any adequately sized material and frame design to sustain the mechanical stresses of the system can be used.

The workbench 1 comprises a work surface 3. This work surface may be at a height to allow easy access for a user standing on a free side of the workbench. An opposite side to the free side may be pushed back against a wall, other equipment or another workbench 1 as the workbench 1 is not designed to be accessed by a user from that side. The user may manipulate objects, such as samples on the work surface 3. This allows, for example, laboratory processes to be carried out to samples on the work surface 3.

The workbench 1 further comprises a second surface 4. For example, this could be a transport layer 4. The transport layer 4 is at a different level to the work surface 3. That is, the transport layer 4 and the work surface 3 are vertically offset from one another. In particular examples, such as shown in the present Figures, the transport layer 4 may be at a level below the work surface 3. By below, it means that in use the transport layer 4 is closer to the ground than the work surface 3. Of course, alternative arrangements are also envisioned such as having the transport layer 4 above the work surface 3.

The transport layer 4 will be described in more detail below, but essentially the transport layer 4 acts to allow a shuttle carrier 7 to be moved around the workbench 1. The shuttle carrier 7 can support one or more samples. For example, the shuttle carrier 7 may have one or more recesses or cavities for receiving a container such as a vial or a test tube. The shuttle carrier 7 may also be referred to as a rack.

In certain examples, there may be a plurality of second surfaces 4. These could be referred to as additional surfaces and/or numbered with consecutive ordinal numbering (i.e. second surface, third surface, fourth surface, etc.). Each additional surface may be at a different level, such as below, the work surface 3. Each additional surface may be at a different level to each other additional surface. One of these additional surfaces may be the transport layer 4 discussed above. Further uses of additional surfaces could include, for example, storage space, a place for consumables, a place for instruments, etc. or a further work surface 3.

A robotic arm 10 may be provided with the workbench system. The workbench 1 may comprise a mounting for the robotic arm 10. This robotic arm 10 may be mounted to a workbench 1 in the workbench system. Alternatively, the robotic arm 10 may be freestanding or attached to a further component or structure. In workbench systems including a plurality of workbenches 1, each workbench 1 may have a corresponding robotic arm. Alternatively, or additionally, one or more workbenches 1 may share a robotic arm 10. While the following disclosure makes reference to the use of a robotic arm 10 in many aspects, this must be interpreted as only when examples including such a robotic arm 10 are used. For the avoidance of doubt, any disclosure relating to any aspect of the system which does not expressly require the presence of a robotic arm 10 may be applied to a workbench system without a robotic arm 10.

The robotic arm 10 may be suitable for moving a sample between the transport layer 4 and the work surface 3. This may be from the transport layer 4 to the work surface 3, or from the work surface 3 to the transport layer 4. The robotic arm 10 may also be able to move the sample around at least a portion of, or the entirety of, one or both of the work surface 3 and/or transport layer 4.

Below the transport layer 4 may be a wiring layer which connects to a control box immediately beneath it or in the vicinity of it. This provides a simple way of making electrical connections to and from the control box for the work surface 3, transport layer 4 and robotic arm 10. The control box may be in the form of a pull-out drawer accessible from the free side for ease of maintenance and to allow easy upgrading of the workbench 1 in the event that new equipment is installed

The robotic arm 10 shown in FIGS. 8 and 9 may be in accordance with the robotic arm 10 disclosed in one or more of the Applicant's earlier patent applications WO 2017/060734 A1, WO 2017/060735 A1, and/or WO 2020/084316 A1, the entire contents of which is hereby incorporated by reference, and reference is made to that document for further details of the robotic arm 10. The robotic arm 10 may swing about its multiple axes rotation between the work surface 3 and the transport layer 4. The robotic arm 10 may be on the free side of the workbench 1.

In alternative examples the robotic arm 10 may have any suitable design. For example, the robotic arm 10 may be a Selective Compliance Assembly Robot Arm or Selective Compliance Articulated Robot Arm, also known as a SCARA.

The robotic arm 10 may be mounted on a rail 11. This allows the robotic arm 10 to move along the rail 11 to access more of the work surface 3 and/or transport layer 4. The rail 11 may be a horizontal rail 11 or a vertical rail 11.

The rail 11 may be at a vertical location just below the transport layer 4. In the horizontal sense, there may be little or no horizontal gap between the work surface 3 and the rail 11 allowing a user to stand comfortably on the free side and to manipulate objects and manually operate laboratory equipment machines on the work surface 3. A gap may be provided at the lowermost portion of the free side to allow a user to stand even closer in a position where their feet are underneath the rail 11 providing comfortable access to the work surface 3. The rail 11 can be a single linear component shared across multiple benches or could be made up of different modules which mate together so as to ensure a smooth transition. The robotic arm 10 can be driven or manually moved along the rail 11 and may be lockable at various locations along the rail 11 if required.

The robotic arm 10 may have a vertical support turret which is mounted on the rail 11 on a carriage so that it can slide along the rail 11. The turret may itself be rotatable on a rotatable platform. The turret may support a series of linkages which are movable together along the turret in a vertical direction along a vertical axis. The linkages may comprise three rotatable links or arms, each of which may be rotatable about a respective rotary axis. The final link (such as the third link) may be provided with an actuator for manipulation of objects on the work surface 3. The actuator may be a simple actuator such as a pincer with a single degree of freedom, or a more complex tool with multiple degrees of freedom. In this example, the robotic arm 10 therefore has three axis of rotation and a linear axis as well as having the option of a further axis of rotation about a rotational axis.

In the depicted example, the robotic arm 10 therefore has three axis of rotation R1, R2 and R3 and a linear axis Z as well as having the option of a further axis of rotation about rotational axis Z.

The workbench 1 may be provided with an additional surface which is directly above the work surface 3. This additional surface may be accessed by the robotic arm 10.

In particular examples of the workbench system, a number of workbenches 1 may be placed adjacent to one another such as shown in FIG. 9. In this adjacent position, an edge of the work surface 3 of a first workbench 1 may be adjacent an edge of the work surface 3 of a second workbench 1. The adjacent edges may be abutting, or within less than 1 cm of each other.

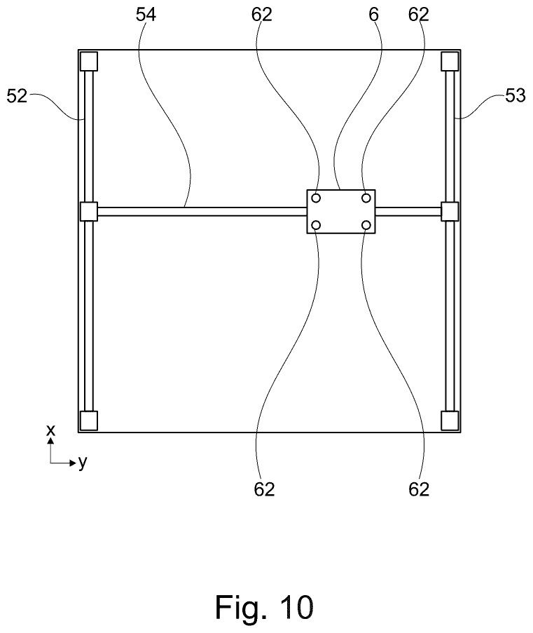

The transport layer 4 will now be explained in detail with particular reference to FIGS. 10 and 11.

The transport layer 4 includes a transport surface 46. This transport surface 46 is suitable for supporting a shuttle carrier 7, which may be carrying one or more samples. The shuttle carrier 7 may be generally as described above. The shuttle carrier 7 is moveable about the transport surface 46. For example, the shuttle carrier 7 may slide over the transport surface 46. Alternatively, the shuttle carrier 7 may include a rotatable component such as a wheel or ball to facilitate its movement about the transport surface 46. The shuttle carrier 7 may comprise one or more low-friction sections for contacting the transport surface 46. For example, the shuttle carrier 7 may comprise polytetrafluoroethylene (PTFE) pads which allow for sliding contact with the transport surface 46.

The transport surface 46 defines a plane. That is, the transport surface 46 has a substantially flat upper surface, which a plane can be drawn through. This plane defines an x direction and a y direction. Although FIG. 10 is below the transport surface 46, the x direction and y direction are clearly shown in this view. Of course, the x direction and the y direction can be reversed for notation. The x direction is perpendicular to the y direction, and the y direction is perpendicular to the x direction.

The transport layer 4 further comprises a magnetic conveyor system which is arranged below the transport surface 4. This magnetic conveyor system comprises a coupling element 6 which includes at least one coupling magnetic region 62. For example, a first coupling magnetic region 62 and a second coupling magnetic region 62. The coupling magnetic region 62 may comprise and/or be a coupling magnet 62, as in the depicted example. The term coupling magnet 62 will therefore be used throughout the present specification, but may refer in any example equally to a coupling magnetic region 62. A coupling magnetic region 62 which is not a coupling magnet 62 may be, for example, a region of magnetic and/or electromagnetic material.

In the depicted example, the coupling element 6 includes 4 coupling magnets 62. The coupling element 6 may be substantially rectangular in the x-y plane, with a coupling magnet 62 arranged adjacent each corner. Particularly, the coupling element 6 may be oblong (i.e. a non-square rectangle). The coupling element 6 is moveable about an underside of the transport surface 46.

The shuttle carrier 7 comprises one or more shuttle magnetic regions 72. For example, there may be a first shuttle magnetic region 72 and a second shuttle magnetic region 72. The shuttle magnetic regions 72 may comprise and/or be a shuttle magnet 72, as in the depicted example. The term shuttle magnet 72 will therefore be used throughout the present specification, but may refer in any example equally to a shuttle magnetic region 72. A shuttle magnetic region 72 which is not a shuttle magnet 72 may be, for example, a region of magnetic and/or electromagnetic material. One or both of the coupling magnetic region 62 and/or the shuttle magnetic region 72 will be a magnet, and the other may simply be a magnetic material. Alternatively, both the coupling magnetic region 62 and the shuttle magnetic region 72 may be magnets.

The shuttle carrier 7 and coupling element 6 may have the same number of shuttle magnets 72 and coupling magnets 62 respectively. Alternatively, there may be a different number of shuttle magnets 72 and coupling magnets 62. The shuttle carrier 7 may be substantially rectangular in the x-y plane, with a shuttle magnet 72 arranged adjacent each corner. Particularly, the shuttle carrier 7 may be oblong (i.e. a non-square rectangle). The shape of the shuttle carrier 7 may generally correspond to the shape of the coupling element 6.

The coupling magnets 62, shuttle magnets 72 and transport surface 46 are selected such that coupling magnets 62 are able to magnetically couple with the shuttle magnets 72 through the transport surface 46. By magnetically couple, this means that there is a magnetic force between the coupling magnets 62 and the shuttle magnets 72 such that movement of the coupling element 6 (and hence the coupling magnets 62) generates a force on the shuttle magnets 72 which leads to movement of the shuttle carrier 7 across the transport surface 46.

This may also be referred to as engagement of the coupling element 6 or coupling magnets 62 with the shuttle carrier 7 or shuttle magnets 72. The term engagement does not mean that every coupling magnet 62 is magnetically coupled with a shuttle magnet 72. As long as one coupling magnet 62 is magnetically coupled with one shuttle magnet 72, the shuttle carrier 7 and coupling element 6 may be defined as engaged. There may be other coupling magnets 62 and/or shuttle magnets 72 which are not magnetically coupled. Engagement of the coupling element 6 with the shuttle carrier 7 is equivalent to engagement of the shuttle carrier 7 with the coupling element 6. Either may be used to refer to this engagement.

The shuttle carrier 7 may comprise one or more shuttle indicators, such as LEDs. These shuttle indicators may be powered through inductive coupling with the coupling element 6. In this sense, the shuttle indicators may be able to indicate to a user that a particular shuttle carrier 7 is in magnetic coupling with the coupling element 6. In further examples, the shuttle indicators may be suitable to indicate a required action for the user. For example, the shuttle indicators may be LEDs which illuminate a certain colour to indicate that samples may be removed from the shuttle carrier 7.

The magnetic conveyor system is configured to move the coupling element 6 in the x direction or the y direction. In a simple example, the magnetic conveyor system may move the coupling element 6 in only one of the x direction or the y direction. Alternatively, the magnetic conveyor system may move the coupling element 6 in both the x direction and the y direction. As noted, the coupling element 6 is below the transport layer 46 and hence the defined plane. However, the x direction and y direction can still be defined in the same direction at this different level.

Thus, the coupling element 6 moves in the x direction or the y direction while it is engaged with the shuttle carrier 7. The magnetic forces between the coupling magnets 62 and shuttle magnets 72 then lead to movement of the shuttle carrier 7 about the transport surface 46. In this sense, the transport layer 4 is able to move a shuttle carrier 7 including one or more samples about the transport surface 46.

The robotic arm 10 may be configured to pick up a sample on the work surface 3 and move it to a shuttle carrier 7 on the transport surface 46. Likewise, the robotic arm 10 may be configured to pick up a sample from the shuttle carrier 7 and move it to the work surface 3. In this sense, the robotic arm 10 can move samples between the work surface 3 and the transport layer 4.

For example, there may be one or more work stations provided at the work surface 3. The robotic arm may move a sample from the transport layer 4, to the work surface 3 and the work station. After work is performed on the sample, the robotic arm 10 may then return the sample back to the shuttle carrier 7 and the transport layer.

The magnetic conveyor system may be any suitable system which allows for movement of the coupling element 6. For example, the coupling element 6 may be mounted on a track. Alternatively, the coupling element 6 may be motorised and include one or more wheels, tracks or the like to allow for its movement.

In the depicted example, the magnetic conveyor system comprises a first rail 52 and a second rail 53 parallel to one another. The first rail 52 is arranged at a first edge of the transport layer 4 and the second rail 53 is arranged at a second edge of the transport layer 4, the first edge opposite the second edge. The first rail 52 and the second rail 53 may be adjacent the respective edge. A third rail 54 may then be provided, extending between the first rail 52 and the second rail 53. Each of the first rail 52, second rail 53, and/or third rail 54 may be a linear actuator or form a part thereof.

The third rail 54 may be moveable along the first rail 52 and the second rail 53 in order to move the coupling element 6 in the x direction. The coupling element 6 may then be moveable along the third rail 53 in order to move the coupling element 6 in the y direction. That is, there may be one or more actuators arranged to drive movement of the third rail 53 with respect to the first rail 52 and the second rail 53. There may be one or more actuators arranged to drive movement of the coupling element 6 with respect to the third rail 53. As noted, the x direction and the y direction are simply for notation and can be switched without changing the present disclosure. Collectively, this group of the first rail 52, second rail 53, third rail 54 and coupling element 6 may be referred to as a gantry system.

This magnetic conveyor system may generally be defined as an XY gantry. In this sense, the coupling element 6 may move about an underside of the transport surface 46 in the x direction and the y direction. FIG. 11 shows this XY gantry in side view.

The workbench 1 may comprise an auxiliary conveyor system, which can also move the shuttle carrier 7 on the transport surface 46. This auxiliary conveyor system may be in accordance with any of the magnetic conveyor systems described in the present specification. Alternatively, the auxiliary conveyor system may be any other suitable arrangement such as a conveyor, conveyor belt, or any other system.

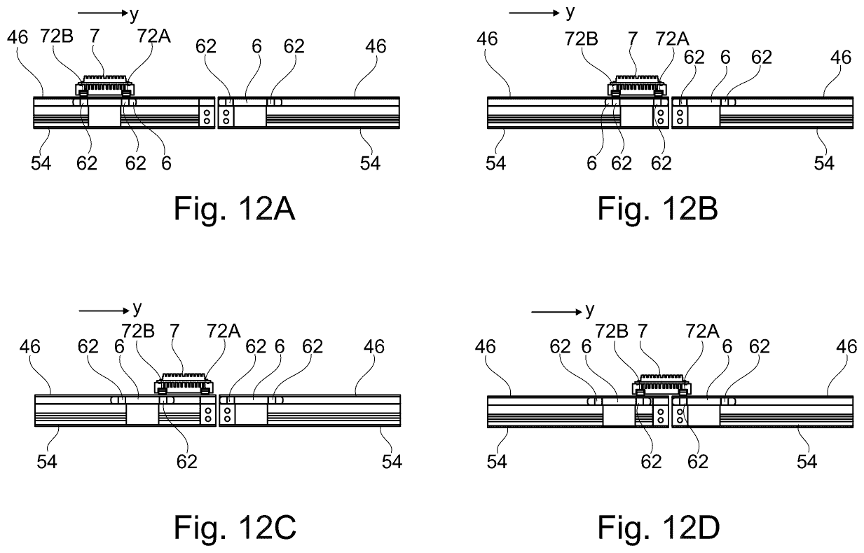

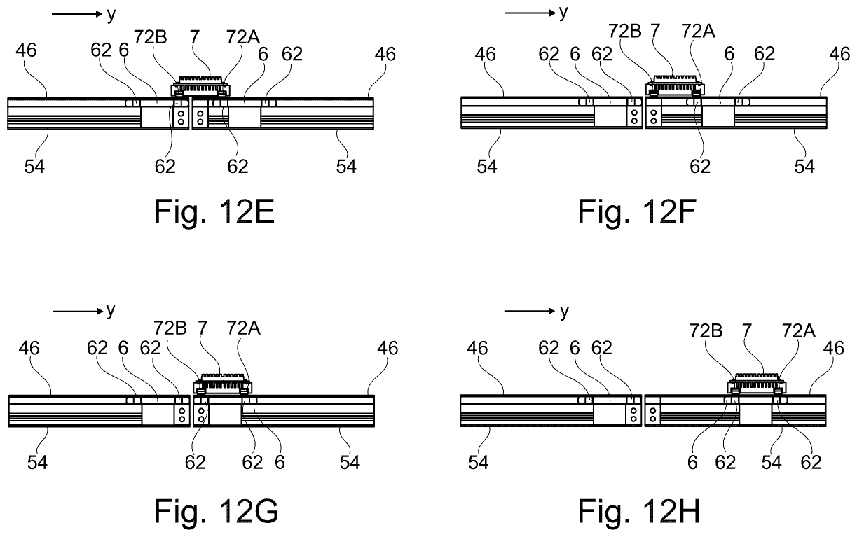

In certain examples, this auxiliary conveyor system may comprise its own coupling element 6 as described in any example of the present specification. The transport surface 46 may be separated into one or more regions, each having a separate conveyor system. In certain examples, the first magnetic conveyor system may move a shuttle carrier 7 around the majority of the transport surface 46. An auxiliary conveyor system may then be used to move a shuttle carrier 7 from the workbench 1 to a further workbench 1, such as using the method described below in relation to FIGS. 12A to 12H.

The coupling element 6 may be selectively engageable and disengageable with the shuttle carrier 7. As noted above, engagement of the coupling element 6 and the shuttle carrier 7 is when the coupling magnets 62 and shuttle magnets 72 are in magnetic coupling. Disengagement is when the coupling magnets 62 and shuttle magnets 72 are not in magnetic coupling. Disengaging may also be referred to as decoupling. This means that the coupling element 6, and hence the coupling magnets 62, can move about the transport layer in the x direction and/or the y direction without moving the shuttle carrier 7.

This selective engagement and disengagement could be achieved by having the coupling magnets 62 and/or the shuttle magnets 72 being electromagnets. The electromagnet could then be selectively provided with electric current to generate a magnetic field. When the electromagnet is provided with electric current the coupling element 6 and shuttle carrier 7 may be engaged. When the electromagnet is not provided with electric current, the coupling element 6 and shuttle carrier 7 may be disengaged.

In a particular example, such as shown in the FIG. 11 the engagement and disengagement of the coupling element 6 and shuttle carrier 7 may be via mechanical separation of the coupling magnets 62 and the shuttle magnets 72. This may particularly be used, for example, when the coupling magnets 62 and the shuttle magnets 72 are permanent magnets and not electromagnets. However, this mechanical separation may also be used when one or both the coupling magnets 62 and shuttle magnets 72 are electromagnets.

The mechanical separation can be achieved by the magnetic conveyor system further comprising an actuation system 66. This actuation system 66 may be configured to move the coupling element 6, or the or each coupling magnet 62, in a linear direction. The actuation system 66 may comprise a single actuator, or a plurality of actuators. For example, the actuation system 66 may comprise a plurality of actuators which independently move a section of the coupling element 6 or one or more coupling magnets 62.

In FIG. 11, the entire coupling element 6 is moved in this linear direction. The linear direction may be defined a z direction, which is perpendicular to the x direction and is perpendicular to the y direction. That is, the z direction may be into and out of the plane defined by the transport layer 46. Thus, the x direction, y direction and z direction may define a Cartesian co-ordinate system.

Movement of the coupling element 6 in this z direction moves the coupling element 6 towards and away from the transport layer 46. When the coupling element 6 and hence the coupling magnets 62 are nearer the transport layer they will be nearer the shuttle carrier 7 and hence the shuttle magnets 72. When the coupling magnets 62 and shuttle magnets 72 are suitably near to one another, the coupling element 6 and shuttle carrier 7 are engaged such that movement of the coupling element 6 causes movement of the shuttle carrier 7.

From this position, the actuation system 66 may move the coupling element 6 away from the transport layer 46 to increase the distance between the coupling magnets 62 and shuttle magnets 72. Once the coupling magnets 62 and shuttle magnets 72 are suitably far from one another, the coupling element 6 and shuttle carrier 7 are disengaged such that movement of the coupling element 6 does not cause movement of the shuttle carrier 7.

This mechanical separation may be particularly relevant where each of the coupling magnets 62 and shuttle magnets 72 are permanent magnets as these cannot be turned on and off to achieve engagement and disengagement. However, the mechanical separation can still be used when one or more of the coupling magnets 62 and/or shuttle magnets 72 are electromagnets.

Thus, the actuation system 66 can move the coupling element 6 in the z direction towards and away from the transport surface 46 to selectively engage and disengage the coupling element 6 and the shuttle carrier 7 on the transport surface 46.

Alternatively, or additionally, the actuation system 66 may be configured to rotate the coupling element 6 about the z direction. This means that a shuttle carrier 7 which is engaged with the coupling element 6 is rotated. This may be the same actuators (and hence same actuation system 66) that also move the coupling element 6 in the z direction, or separate actuators and/or actuation system 66. In certain examples, the coupling element 6 can only move in the z direction and not rotate about the z direction. In further examples the coupling element 6 can only rotate about the z direction and not move in the z direction. In further examples still the coupling element 6 can move in the z direction and about the z direction.

The coupling element 6 may comprise one or more sensors arranged to detect the presence of a shuttle carrier 7 above the coupling element 6. For example, the coupling element 6 may comprise one or more Hall effect sensors which would detect the magnetic field of the shuttle magnets 72.

In particular examples, the transport surface 46 may have a handover region. This handover region may be adjacent to an edge of the transport surface 46. This handover region may be reachable for picking up a sample from a shuttle carrier 7 in the handover region, or putting a sample down in a shuttle carrier 7 in the handover region. This may be, for example, reachable by a user of the workbench system. Alternatively, or additionally, the handover region may be reachable by the robotic arm 10.

For example, as best shown in FIG. 8 the transport surface 46 may extend, in plan view, beyond an edge of the work surface 3. The extension of the transport surface 46 beyond the work surface 3 may be the handover region. The robotic arm 10 may be arranged generally above this extension of the transport surface 46. Thus, the robotic arm 10 may be easily able to reach this handover region.

The handover region may comprise an anchoring system for retaining a shuttle carrier 7 in the handover region. For example, the anchoring system may be a selectively engageable anchoring magnet. This may engage with, for example, a shuttle magnet 72 of the shuttle carrier 7. Alternatively, or additionally, the anchoring system may include a mechanical stop, such as a solenoid, which engages with a catch on a shuttle carrier 7 to hold it in place. The anchoring system may include one or more handover bays which may comprise walls or other elements to hold a shuttle carrier 7 in place. The handover region may be sized to accommodate a plurality of shuttle carriers 7.

The coupling element 6, or any other part of the magnetic conveyor system, may include an identification reader. The shuttle carrier 7 may then include identification information which is readable by the identification reader. The identification information may be changeable so as to provide contextual information about the shuttle carrier 7 or any samples on the shuttle carrier 7. This identification information may provide information about the shuttle carrier 7 including but not limited to a serial number of the shuttle carrier, details about samples of the shuttle carrier 7, a history of processing of the shuttle carrier 7, or any other information. The transport layer 46 may be such that the identification reader can read the identification information through the transport layer 46. For example, the identification reader may be a radio frequency identification (RFID) reader and the identification information may be an RFID tag.

The workbench system may further comprise sensing apparatus for sensing the position of any shuttle carriers 7 on the transport layer 46. This sensing apparatus may be the same as the identification reader discussed above. Alternatively, or additionally, the sensing apparatus may include a camera with a field of vision including the transport layer 46. Computer vision analysis may be applied to a feed from the camera to determine the location of any shuttle carriers 7 on the transport layer 46. In workbench systems with a plurality of workbenches 1, the sensing apparatus may be shared between multiple workbenches 1.

The workbench system may further comprise other sensing apparatus for sensing parameters of samples on shuttle carriers 7 on the transport layer 46. For example, these parameters may include one or more of temperature, pressure, and/or humidity. The shuttle carrier 7 may comprise means for controlling the sensed parameter. This could be, for example, heating/cooling means.

A method of transporting a sample is therefore provided. A workbench 1 as described above, with or without any of the optional features, is provided. A shuttle carrier 7 is then provided on the transport surface 46 of this workbench 1. The shuttle carrier 7 is carrying a sample to be transported. The coupling element 6 is then magnetically coupled to the shuttle carrier 7, such as by engaging the coupling element 6 and the shuttle carrier 7. The coupling element 6 is then moved by the magnetic conveyor system. This results in movement of the shuttle carrier 7 due to the magnetic coupling. The sample can then be moved to the work surface 3. For example, the sample may be picked up by the robotic arm 10 and then moved to the work surface 3 by the robotic arm 10.

A particular workbench system is defined with a first workbench 1 and a second workbench 2.

The first workbench 1 includes a work surface 3 and a transport layer 4 at a different level to the work surface 3. The transport layer 4 of the first workbench 1 comprising a transport surface 46 for supporting a shuttle carrier 7. The shuttle carrier 7 suitable for carrying one or more samples. The transport surface 46 defines a plane with an x direction and a perpendicular y direction. A magnetic conveyor system is arranged below the transport surface 46. The magnetic conveyor system comprises a coupling element 6 including a coupling magnet 62. The coupling magnet 62 and hence coupling element 6 is for magnetic coupling through the transport surface 46 with a shuttle magnet 72 on a shuttle carrier 7 on the transport surface 46. The magnetic conveyor system is configured to move the coupling element 6 in the x direction or the y direction.

The second workbench 1 also includes a work surface 3 and a transport layer 4 at a different level to the work surface 3. The transport layer 4 of the first workbench 1 comprising a transport surface 46 for supporting a shuttle carrier 7. The shuttle carrier 7 suitable for carrying one or more samples. The transport surface 46 defines a plane with an x direction and a perpendicular y direction. A magnetic conveyor system is arranged below the transport surface 46. The magnetic conveyor system comprises a coupling element 6 including a coupling magnet 62. The coupling magnet 62 and hence coupling element 6 is for magnetic coupling through the transport surface 46 with a shuttle magnet 72 on a shuttle carrier 7 on the transport surface 46. The magnetic conveyor system is configured to move the coupling element 6 in the x direction or the y direction.

In this sense, the first workbench 1 and the second workbench 1 may be substantially identical. The workbench system may further comprise a robotic arm 10 which is suitable for moving a sample between the transport layer 4 and the work surface 3 of one or both of the first workbench 1 and/or the second workbench 1. For example, the robotic arm 10 may be arranged on a rail 11 of the first workbench or the second workbench 1. Each of the first workbench 1 and the second workbench 1 may have a corresponding rail 11 which allows the robotic arm 10 to move between the rail 11 of the first workbench 1 to the rail 11 of the second workbench 1. The rails 11 may have an open ended configuration at the interface between the two workbenches 1.

The transport layer 4 of the first workbench 1 may be suitable for passing a shuttle carrier 7 to the transport layer 4 of the second workbench 1. Likewise, the transport layer 4 of the second workbench 1 may be suitable for passing a shuttle carrier 7 to the transport layer 4 of the first workbench 1. That is, a shuttle carrier 7 may be passed between the respective transport surfaces.

The precise passing method may be any suitable method. A particular method of passing a shuttle carrier 7 between a first workbench 1 and a second workbench 1 will be described below in relation to FIG. 12A to 12H. The shuttle carrier 7 includes a plurality of shuttle magnets 72. Each workbench 1 comprises a transport surface 46 for supporting a shuttle carrier 7. The transport surfaces 46 each defining a plane with an x direction and a perpendicular y direction. The first workbench 1 and the second workbench 1 may be adjacent in the x direction or the y direction. Any component of the first workbench 1 may be defined as the “first”—such as a first transport surface 46, and any component of the second workbench 1 may be defined as the “second”—such as a second transport surface 46.

A magnetic conveyor system is arranged below the transport surface 46. The magnetic conveyor system comprises a coupling element 6 including at least one coupling magnet 62 for magnetic coupling through the transport surface 46 with a shuttle magnet 72 on a shuttle carrier 7 on the transport surface 46.

One or both of the first workbench 1 and/or the second workbench 2 may be as described above, with or without any of the optional features.

The magnetic conveyor system is configured to move the coupling element 6 in the x direction and/or the y direction. Particularly, this may be the direction in which the first workbench 1 and the second workbench 1 are adjacent to one another. That is, if the first workbench 1 is adjacent the second workbench 2 in the y direction, the magnetic conveyor system may be configured to move the coupling element 6 in at least the y direction.

FIG. 12A shows the shuttle carrier 7 engaged with the coupling element 6 of the first workbench 1. As above, engaged with means that the coupling magnets 62 are in magnetic coupling with the shuttle magnets 72 such that movement of the coupling element 6 (and hence the coupling magnets 62) generates a force on the shuttle magnets 72 which leads to movement of the shuttle carrier 7 across the transport surface 46.

From this position, the coupling element 6 of the first workbench 1 is moved with the magnetic conveyor system. This leads to movement of the shuttle carrier 7 across the work surface 46. The shuttle carrier 7 is moved to a position adjacent to an edge of the transport surface 46 of the first workbench 1 as shown in FIG. 12B. This edge is an edge of the first workbench 1 adjacent to the second workbench 1. There is therefore a corresponding edge of the transport surface 46 of the second workbench 1 adjacent to this edge. This movement may be, for example, in the y direction as shown, or the x direction. The direction of movement towards the edge of the transport surface 46 of the first workbench 1 may be defined as a first direction.

The shuttle carrier 7 is then disengaged from the coupling element 6. This may be via any of the disengagement methods discussed above, or any other suitable method. Again, disengagement is when the coupling magnets 62 and shuttle magnets 72 are not in magnetic coupling. This means that the coupling element 6, and hence the coupling magnets 62, can move about the transport layer without moving the shuttle carrier 7.

The coupling element 6 is then moved away from the edge of the transport layer 46. This may be in a direction opposite to the movement above towards the edge. For example this may be in a negative y direction as shown in FIGS. 12A to 12H. This may be defined as a second direction, opposite to the first direction.

The coupling element 6 is then engaged with a second magnet 72B of the plurality of shuttle magnets 72. A first magnet 72A is not engaged with the coupling element 6. The first magnet 72A may be spaced along the shuttle carrier 7 from the second magnet 72B in the first direction. The first magnet 72A may be provided at a first end of the shuttle carrier 7 and the second magnet 72B may be provided at a second end of the shuttle carrier 7. The second end being opposite to the first end.

There may be a plurality of first magnets 72A provided at the first end of the shuttle carrier 7, and/or a plurality of second magnets 72B arranged at the second end of the shuttle carrier 7. For example the shuttle carrier 7 may be substantially rectangular in the x-y plane, with a first magnet 72A or a second magnet 72B arranged adjacent each corner.

Particularly, the coupling element 6 may be oblong (i.e. a non-square rectangle). The corners can be paired across the shortest side. Each pair of corners may define a respective end of the shuttle carrier 7.

The coupling element 6 may then be moved in order to move the shuttle carrier 7 to a position where the shuttle carrier 7 overhangs the edge of the transport surface 46 of the first workbench 1. By overhangs, it is meant that in plan view the shuttle carrier 7 extends beyond the edge of the transport surface 46 of the first workbench 1. In this position, as shown in FIG. 12D, the first magnet 72A is now above the transport surface 46 of the second workbench 1.

While the depicted example shows the shuttle carrier 7 overhanging the edge of the transport surface 46 of the first workbench 1, it is also appreciated that other methods may be used. For example, the coupling element 6 of the second workbench 1 may be able to magnetically couple with a shuttle carrier 7 which is on the transport surface 46 of the first workbench 1. For example, in a transfer region of the transport surface 46. This transfer region may be, for example, part of a shared transport surface 46 for the first workbench 1 and second workbench 2. Alternatively, the shuttle carrier 7 of the second workbench 1 may protrude from a footprint of the transport surface 46 of the second workbench 1 such that it extends underneath the transport surface 46 of the first workbench 1. This may be, for example, via a selectively extendable member or simply as a position that the shuttle carrier 7 is driveable to.

The coupling element 6 of the second workbench 1 is then engaged with the first magnet 72A. The coupling element 6 of the second workbench 1 is then moved such that the shuttle carrier 7 is moved to a position adjacent an edge of the transport surface 46 of the second workbench 1. This may be the corresponding edge of the transport surface 46 of the second workbench 1 adjacent to the edge of the first workbench 1. This position is shown in FIG. 12F. The shuttle carrier 7 is then fully supported by the transport surface 46 of the second workbench 1. That is, all contact points of the shuttle carrier 7 are entirely within an outer boundary of the transport surface 46 of the second workbench 1.

The coupling element 6 of the first workbench 1 may remain engaged with second magnet 72B during an initial stage of this movement. In this initial stage, both the first coupling element 6 and the second coupling element 6 may move to move the shuttle carrier 7. This is shown in the movement between FIGS. 12D and 12E. The coupling element 6 of the first workbench 1 can then disengage from the second magnet 72B in order to allow the shuttle carrier 7 to move to be fully supported by the transport surface 46 of the second workbench 1. Alternatively, the coupling element 6 of the first workbench may disengage from second magnet 72B before or during the movement between FIGS. 12D and 12E.

From the position of FIG. 12F, the coupling element 6 of the second workbench 1 is then disengaged from the shuttle carrier 7. The coupling element 6 is then moved towards the edge of the transport surface 46 of the second workbench 1. This movement may be in the second direction.

The coupling element 6 of the second workbench 1 is then engaged with the second magnet 72B of the shuttle carrier 7. The coupling element 6 of the second workbench 1 may be engaged with both the first magnet 72A and the second magnet 72B of the shuttle carrier 7.

The coupling element 6 of the second workbench 1 is then moved in order to move the shuttle carrier 7 to a further position where it is fully supported on the transport layer 46 of the second workbench 1. The shuttle carrier 7 can therefore be moved to any position on the transport layer 46 of the second workbench 1.

In this sense, the shuttle carrier 7 is passed between the first workbench 1 and the second workbench 1. The workbench system may comprise a plurality of workbenches 1 arranged in such an adjacent manner. This method can be repeated between each workbench 1 to allow the shuttle carrier 7 to be passed between any number of workbenches 1. FIG. 9 shows a right-angle turn between three adjacent workbenches 1. This method can equally be applied to such a series of workbenches 1. One pass will be in the x direction, followed by a pass in the y direction.

FIG. 12A shows an example where each coupling element 6 comprises a plurality of coupling magnets 62, and each shuttle magnet 72 is engaged with a corresponding shuttle magnet 72. It may be that one shuttle magnet 72 engages with a plurality of coupling magnets 62, or that one coupling magnet 62 engages with a plurality of shuttle magnets 72. In this example, there are no disengaged shuttle magnets 72 in this initial state.

An alternative example is also considered in which at least a first magnet 72 of the plurality of shuttle magnets 72 is not engaged with any coupling magnet 62 in this initial state. This may, for example, generally correspond to the arrangement shown in FIG. 12C which will be discussed later. For example, the coupling element 6 may only engage with a subset of the total number of coupling magnets 62.

In this alternative example, the handover between the first coupling element 6 and the second coupling element 6 may be simplified. The first coupling element 6 can be moved such that the shuttle carrier 7 overhangs the edge of the first transport surface 46 and the first magnet 72A of the shuttle carrier 7 is above the second transport surface 46. From this position, the second coupling element 6 can engage with the first magnet 72A of the shuttle carrier 7. The second coupling element 6 can then move moved such that the shuttle carrier 7 is moved to a position where it is fully supported on the second workbench 46. In this arrangement, back-and-forth movement of each coupling element 6 in the handover can be reduced.

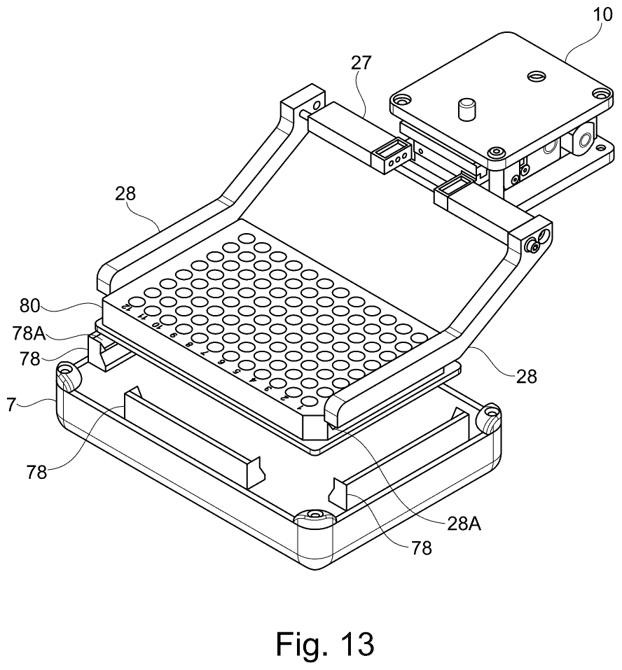

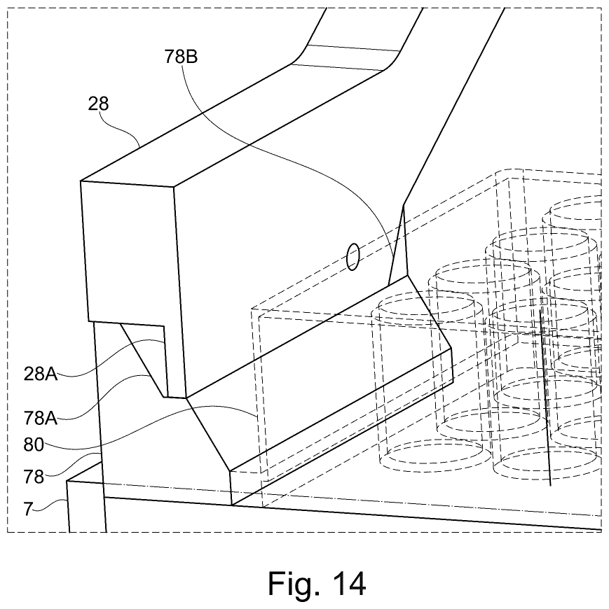

FIGS. 13 to 15E show operation of a particular example of robotic arm 10, which co-operates with the shuttle carrier 7 to allow for alignment. This alignment takes advantage of the selective compliance of the shuttle carrier 7 with the coupling element 6 through the transport surface 46. That is, because the engagement is magnetic coupling through the transport surface 46 the shuttle carrier 7 is able to move about the transport surface 46 to align with the robotic arm 10 without disengaging from the coupling element 6.

A perspective view of an end effector of the robotic arm 10 and the shuttle carrier 7 is shown in FIG. 13. The robotic arm 10 comprises an actuator 27 for manipulation of objects. For example, the actuator 27 may comprise a pair of arms 28 which are able to grip a sample. In the example of FIGS. 13 to 15E, the sample is a sample tray 80. This sample tray 80 comprises one or more recesses or cavities for receiving a container such as a vial or a test tube.

The robotic arm 10 may comprise an alignment protrusion 28A. In certain examples, each arm 28 may comprise an alignment protrusion 28A. These alignment protrusions 28A extend towards the shuttle carrier 7.

The shuttle carrier 7 may comprise an alignment member 78. For example, the alignment member 78 may comprise an alignment surface 78A for engaging with the alignment protrusions 28A to align the shuttle carrier 7 and robotic arm 10. There may be a complementary alignment surface 78A for each alignment protrusion 28A. Alternatively, there may be more alignment surfaces 78A than alignment protrusions 28A to allow for the robotic arm 10 to grip the sample tray 80 from different directions. The alignment member 78 may further comprise a second alignment surface 78B for engaging with the alignment protrusions 28A to align the shuttle carrier 7 and robotic arm 10 in a different direction than the first alignment surface 78A. The two directions may be the x direction and the y direction of the transport surface 46. Each alignment surface 78A, 78B may be a chamfered surface.

The shuttle carrier 7 may further comprise a sample-receiving surface which supports the sample tray 80. This sample-receiving surface may be moveable in use in a z direction towards and away from the transport surface, the z direction perpendicular to the x direction and the y direction. The sample-receiving surface may be supported by a biasing member. For example, the biasing member may be one or more springs, living hinges, resilient material or the like. The biasing member may bias the sample-receiving surface away from the transport surface 46.

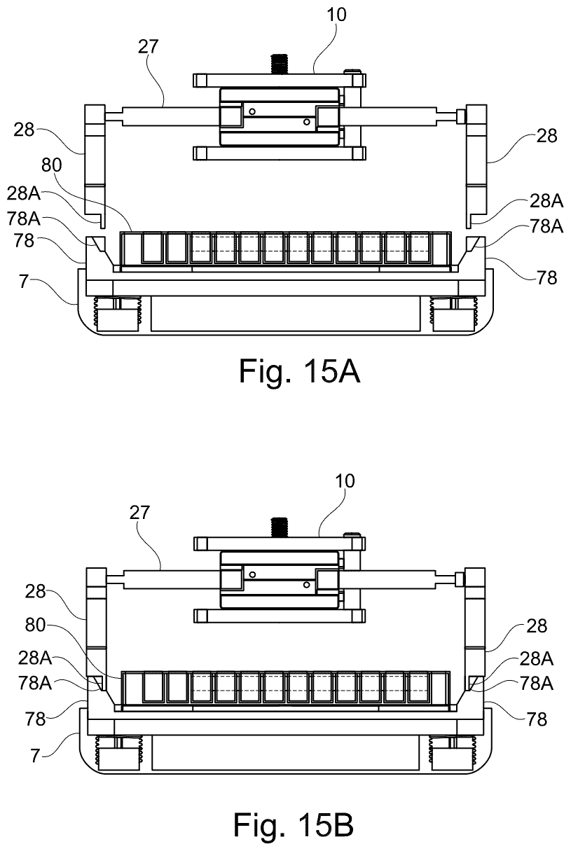

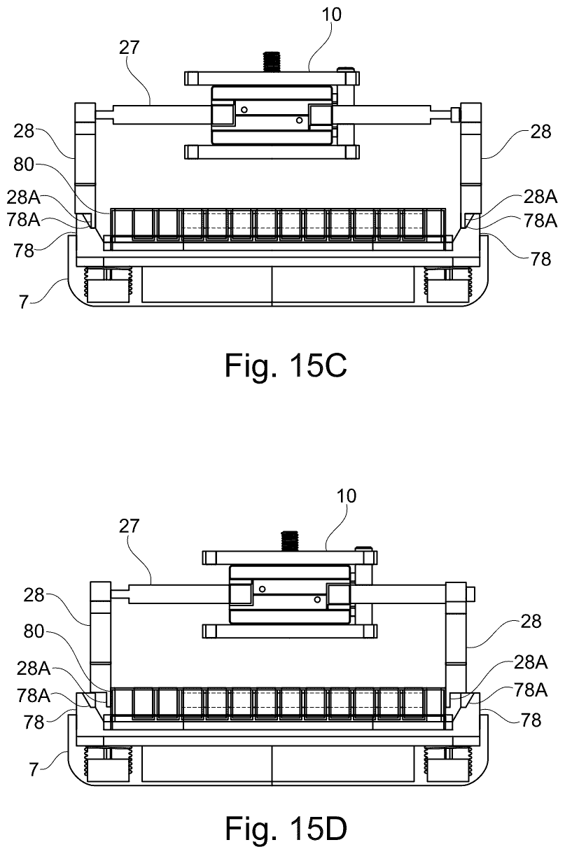

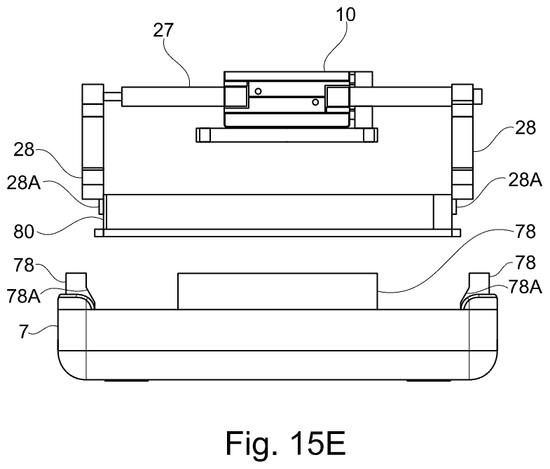

Operation of this alignment system is described in relation to FIGS. 15A to 15E. FIG. 15A shows a shuttle carrier 7 holding a sample tray 80, with a robotic arm 10 above this shuttle carrier 7 and ready to pick up the sample tray 80.

The robotic arm 10 moves towards the shuttle carrier 7, which may be out of alignment with each other. The alignment protrusions 28A of the robotic arm 10 engage with the alignment surfaces 78A of the shuttle carrier 7. If the shuttle carrier 7 and robotic arm 10 are out of alignment, the contact between the alignment protrusions 28A and the alignment surfaces 78A will move the shuttle carrier 7 about the transport surface 46 until they are aligned as shown in FIG. 15B. The use of magnetic coupling between the shuttle carrier 7 and the coupling element 6 through the transport surface 46 allows the shuttle carrier 7 to move against the magnetic force. This therefore results in alignment of the shuttle carrier 7 and robotic arm in the x direction and the y direction of the transport surface 46.

The robotic arm 10 then moves further in the z direction towards the transport surface 46. This moves the sample-receiving surface against the force of the biasing member towards the transport surface 46, as shown in FIG. 15C. This allows for z alignment of the sample tray 80 and the robotic arm 10.

From this position, the robotic arm 10 grips the sample tray 80 as shown in FIG. 15D. The alignment protrusions 28A and alignment surfaces 78A may remain engaged in this position so as to keep the sample-receiving surface in the same position against the force of the biasing member.

With the sample tray 80 gripped, the robotic arm 10 then moves away from the transport surface 46 in the z direction as shown in FIG. 15E. This lifts the sample tray 80 from the shuttle carrier 7. The robotic arm 10 can then continue manipulation of the sample tray 80, such as moving it to the work surface 3. When the alignment protrusions 28A and alignment surfaces 78A disengage from one another, the shuttle carrier 7 can then move about the transport surface 46 again back to the position of maximum magnetic coupling with the shuttle carrier 6.

This method can equally be applied when depositing a sample tray 80 on the shuttle carrier 7.

In this sense, the robotic arm 10 and shuttle carrier 7 can take advantage of the magnetic coupling to ensure correct alignment when picking up and depositing a sample such as a sample tray 80.
Clause 1. A workbench system comprising:
a first workbench having a work surface and a transport layer at a different level to the work surface,
wherein the transport layer comprises:
a transport surface for supporting a shuttle carrier for carrying one or more samples, the transport surface defining a plane with an x direction and a perpendicular y direction; and
a magnetic conveyor system arranged below the transport surface, comprising a coupling element for magnetic coupling through the transport surface in use with a shuttle carrier on the transport surface, the magnetic conveyor system configured to move the coupling element in the x direction or the y direction.
Clause 2. The workbench system of clause 1, wherein the first workbench further comprises a mounting for a robotic arm.
Clause 3. The workbench system of any preceding clause, further comprising a robotic arm for moving a sample between the transport layer and the work surface.
Clause 4. The workbench system of any preceding clause, wherein the magnetic conveyor system is configured to move the coupling element in both the x direction and the y direction.
Clause 5. The workbench system of any preceding clause, wherein the coupling element comprises a coupling magnet for magnetic coupling through the transport surface in use with a shuttle carrier on the transport surface.
Clause 6. The workbench system of clause 5, wherein the coupling element comprises a plurality of coupling magnets for magnetic coupling through the transport surface in use with a shuttle carrier on the transport surface.
Clause 7. The workbench system of clause 5 or 6, wherein the or each coupling magnet is a permanent magnet.
Clause 8. The workbench system of any preceding clause, wherein the coupling element is selectively engageable and disengageable in use with a shuttle carrier on the transport surface.
Clause 9. The workbench system of any preceding clause, wherein the magnetic conveyor system further comprises an actuation system configured to move the coupling element in a z direction towards and away from the transport surface, the z direction perpendicular to the x direction and the y direction, for engaging and disengaging the coupling element and a shuttle carrier on the transport surface.
Clause 10. The workbench system of any preceding clause, wherein the magnetic conveyor system further comprises an actuation system configured to rotate the coupling element about a z direction, the z direction perpendicular to the x direction and the y direction.
Clause 11. The workbench system of any preceding clause, wherein the magnetic conveyor system comprises a first rail and a second parallel rail, arranged at opposite edges of the transport layer, and a third rail extending between the first rail and the second rail, wherein:
the third rail is configured to move along the first rail and the second rail to move the coupling element in the x direction; and
the coupling element is configured to move along the third rail to move in the y direction.
Clause 12. The workbench system of any preceding clause, wherein the coupling element further comprises an identification reader arranged to read identification information through the transport surface of a shuttle carrier carried on the transport surface.
Clause 13. The workbench system of any preceding clause, wherein the transport surface comprises a handover region, wherein the handover region is reachable for moving a sample between the transport surface and the work surface.
Clause 14. The workbench system of clause 13, when dependent upon clause 3, wherein the handover region is reachable by the robotic arm for moving a sample between the transport surface and the work surface.
Clause 15. The workbench system of clause 13 or 14, further comprising an anchoring system for retaining a shuttle carrier in the handover region of the transport surface.
Clause 16. The workbench system of any of clauses 13 to 15, wherein the handover region is adjacent to an edge of the transport surface.
Clause 17. The workbench system of any preceding clause, wherein the transport layer is at a level below the work surface.
Clause 18. The workbench system of any preceding clause, further comprising an auxiliary conveyor system for moving a shuttle carrier on the transport surface.
Clause 19. The workbench system of any preceding clause, further comprising:
a second workbench adjacent to the first workbench, the second workbench having a work surface and a transport layer at a different level to the work surface,
wherein the transport layer of the second workbench comprises:
a transport surface for supporting a shuttle carrier for carrying one or more samples, the transport surface defining a plane with an x direction and a perpendicular y direction;
a magnetic conveyor system arranged below the transport surface, comprising a coupling element for magnetic coupling through the transport surface with a shuttle carrier on the transport surface, the magnetic conveyor system configured to move the coupling element in the x direction and/or the y direction.
Clause 20. The workbench system of any preceding clause, further comprising a shuttle carrier for carrying one or more samples, the shuttle carrier comprising a plurality of shuttle magnetic regions.
Clause 21. The workbench system of clause 20, wherein the plurality of shuttle magnetic regions comprises a first magnetic region at a first end of the shuttle carrier and a second magnetic region at a second end of the shuttle carrier, the second end opposite to the first end.
Clause 22. The workbench system of clause 20 or 21, wherein each shuttle magnetic region comprises a shuttle magnet.
Clause 23. The workbench system of any of clauses 20 to 22, when dependent on clause 3, wherein the robotic arm comprises an alignment protrusion and the shuttle carrier further comprises a complementary alignment surface, the alignment protrusion arranged to engage the complementary alignment surface to move the shuttle carrier in the x direction and/or the y direction.
Clause 24. The workbench system of clause 23, wherein the alignment surface is a chamfered surface.
Clause 25. The workbench system of any of clauses 20 to 24, wherein the shuttle carrier further comprises a sample-receiving surface supported by a biasing member, the biasing member biasing the sample-receiving surface in in a z direction away from the transport surface, the z direction perpendicular to the x direction and the y direction.
Clause 26. A method of transporting a sample comprising the steps of:
providing a workbench system according to any preceding clause;
providing a shuttle carrier carrying a sample on the transport surface;
magnetically coupling the coupling element and the shuttle carrier;
moving the coupling element with the magnetic conveyor system to thereby move the shuttle carrier; and
moving the sample to the work surface.
Clause 27. The method of clause 26, wherein the workbench system further comprises a robotic arm for moving a sample between the transport layer and the work surface, and the method further comprises the step of picking up the sample with the robotic arm.
Clause 28. A method of passing a shuttle carrier for carrying one or more samples between a first workbench and a second workbench adjacent to the first workbench, the shuttle carrier comprising a plurality of shuttle magnetic regions, wherein each workbench comprises a transport surface for supporting a shuttle carrier, the transport surface defining a plane with an x direction and a perpendicular y direction; and a magnetic conveyor system arranged below the transport surface, comprising a coupling element including a coupling magnetic region, wherein one or both of the shuttle magnetic regions or the coupling magnetic region is a magnet, the coupling magnetic region for magnetic coupling through the transport surface with a shuttle magnetic region on a shuttle carrier on the transport surface, the magnetic conveyor system configured to move the coupling element in the x direction and/or the y direction, the method comprising the steps of:
engaging the shuttle carrier with the coupling element of the first workbench;
moving the coupling element of the first workbench to move the shuttle carrier to an edge of the transport surface of the first workbench;
engaging the shuttle carrier with the coupling element of the second workbench; and
moving the coupling element of the second workbench to move the shuttle carrier to a position where the shuttle carrier is fully supported on the transport layer of the second workbench.
Clause 29. The method of clause 28, wherein in step ii, the coupling element moves the shuttle carrier to a position where the shuttle carrier overhangs the edge of the transport surface of the first workbench with at least a first shuttle magnetic region of the plurality of shuttle magnetic regions of the shuttle carrier above the transport surface of the second workbench.
Clause 30. The method of clause 28 or 29, wherein the plurality of shuttle magnetic regions comprises a first shuttle magnetic region and a second shuttle magnetic region, and the coupling element of the first workbench comprises a first coupling magnetic region and a second coupling magnetic region, wherein in step i the first shuttle magnetic region of the shuttle carrier is engaged with the first coupling magnetic region of the coupling element of the first workbench and the second shuttle magnetic region of the shuttle carrier with the second coupling magnetic region of the coupling element of the first workbench, the method further comprising, between step i and step ii, the steps of:
i-1. moving the coupling element of the first workbench to move the shuttle carrier to a position where the shuttle carrier is adjacent the edge of the transport surface of the first workbench;
i-2. disengaging the first shuttle magnetic region of the shuttle carrier from the first coupling magnetic region of the coupling element of the first workbench and the second shuttle magnetic region of the shuttle carrier from the second coupling magnetic region of the coupling element of the first workbench;
i-3. moving the coupling element away from the edge of the transport surface of the first workbench; and
i-4. engaging the second shuttle magnetic region of the shuttle carrier with the first coupling magnetic region of the coupling element of the first workbench.
Clause 31. The method of any of clauses 28 to 30, wherein the plurality of shuttle magnetic regions comprises a first shuttle magnetic region and a second shuttle magnetic region, and the coupling element of the second workbench comprises a first coupling magnetic region and a second coupling magnetic region, wherein in step iii the first shuttle magnetic region of the shuttle carrier is engaged with the second coupling magnetic region of the coupling element of the second workbench, the method further comprising, between step iii and step iv, the steps of:
iii-1. moving the coupling element of the second workbench to move the shuttle carrier to a position where the shuttle carrier is adjacent an edge of the transport surface of the second workbench;
iii-2. disengaging the first shuttle magnetic region of the shuttle carrier from the second coupling magnetic region of the coupling element of the second workbench;
iii-3. moving the coupling element towards the edge of the transport surface of the second workbench; and
iii-4. engaging the first shuttle magnetic region of the shuttle carrier with the first coupling magnetic region of the coupling element of the second workbench and the second shuttle magnetic region of the shuttle carrier with the second coupling magnetic region of the coupling element of the second workbench.
Clause 32. The method of clause 30 or 31, wherein the first shuttle magnetic region is provided at a first end of the shuttle carrier and the second shuttle magnetic region is provided at a second end of the shuttle carrier, the second end opposite to the first end.
Clause 33. The method of any of clauses 28 to 32, wherein:
each coupling element comprises a plurality of coupling magnetic regions;
at steps i and iv each of the shuttle magnetic regions is engaged with a corresponding coupling magnetic region.
Clause 34. The method of any of clauses 28 to 33, wherein each magnetic region comprises a magnet.

While the foregoing is directed to embodiments of the present disclosure, other and further embodiments may be devised without departing from the basic scope thereof, and the scope thereof is determined by the claims that follow.

1. A workbench system comprising:
a first workbench having a work surface accessible to a user from a free side of the workbench for user manipulation of objects on the work surface;
and a robotic arm mounted on the free side of the workbench, the robotic arm having at least three degrees of freedom so as to be able to manipulate objects on the work surface; further comprising a rail extending horizontally along the free side of the workbench, the robotic arm being slidably mounted on the rail.

2. The workbench system according to claim 1, wherein the workbench further comprises a second surface at a level different from that of the work surface, the robotic arm being configured to be able to manipulate objects on the second surface.

3. The workbench system according to claim 2, wherein the second surface is a transport surface via which objects are transported to and from the workbench.

4. The workbench system according to claim 2, wherein the robotic arm is movable along a vertical axis between the work surface and second surface.

5. The workbench system according to claim 2, wherein the second surface is directly below the work surface.

6. The workbench system according to claim 1, wherein the workbench further comprises an additional surface different from that of the work surface, the robotic arm being configured to be able to manipulate objects on the additional surface.

7. The workbench system according to claim 1, wherein the rail is provided with a coupling at one end for coupling, in use, to a rail of an adjacent workbench.

8. The workbench system according to claim 1, further comprising a second workbench attachable to the first workbench and having a work surface accessible to a user from a free side of the workbench.

9. The workbench system according to claim 8, wherein the second workbench has a rail extending horizontally along the free side of the workbench and coupled to the rail of the first workbench such that the robotic arm can move between the rails of the two workbenches.

10. The workbench system according to claim 1, wherein at the free side, the horizontal distance between the work surface and the rail is less than 30 cm, or less than 20 cm, or less than 10 cm.

11. The workbench system according to claim 1, wherein the rail is partially or entirely directly below the work surface.

12. The workbench system according to claim 1, wherein the rail is configured, in use, to allow the robotic arm to move in the region occupied, in use, by a user standing adjacent to the free side of the workbench to access the work surface.

13. The workbench system according to claim 1, wherein, at lowermost part of the free side of the workbench there is a gap of at least 5 cm high to allow a user's feet to be positioned under the workbench.

14. The workbench system according to claim 1, wherein a control box containing electronics for the robotic arm is supported in the workbench and is withdrawable at the free side of the workbench.

15. A method of equipping a laboratory, the method comprising installing a workbench system, including a first workbench having a work surface accessible to a user from a free side of the workbench for user manipulation of objects on the work surface;
and a robotic arm mounted on the free side of the workbench, the robotic arm having at least three degrees of freedom so as to be able to manipulate objects on the work surface; the method further comprising installing the first workbench such that the side of the workbench opposite to the free side is installed against an object, and the free side of the workbench is unobstructed.

16. The method according to claim 15, wherein the object is a wall, another workbench or other equipment.

17. The method according to claim 15, further comprising installing further workbench systems in the laboratory.

18. The method according to claim 17, wherein at least one of the further workbench systems is a second workbench which is attached to the first workbench and having a work surface accessible to a user from a free side of the workbench.

19. The method according to claim 18, wherein the first and second workbenches each have a rail extending along the free side of the workbench, and the method further comprises coupling to the rail of the first and second workbenches such that the robotic arm can move between the rails of two workbenches.

20. The method according to claim 15, wherein the workbench system is a workbench system according to claim 1.

21. A workbench system comprising:
a first workbench having a work surface accessible to a user for user manipulation of objects on the work surface;
a transport surface at a level below the work surface:
a robotic arm mounted to the workbench, and having at least three degrees of movement so as to be able to manipulate objects on the work surface and on the transport surface;
wherein the transport surface is provided with a magnetic conveyor system to transport objects to and from the workbench.
